(19) United States
(12) Patent Application Publication
(10) Pub. No.: US 2019/0281845 A1
(43) Pub. Date: Sep. 19, 2019

(54) EDIBLE BIO-ACTIVE FILMS BASED ON CHITOSAN OR A MIXTURE OF QUINOA PROTEIN-CHITOSAN; SHEETS HAVING CHITOSAN-TRIPOLYPHOSPHATE-THYMOL NANOPARTICLES; PRODUCTION METHOD; BIO-PACKAGING COMPRISING SAME; AND USE THEREOF IN FRESH FRUIT WITH A LOW PH

(71) Applicant: Universidad de Chile, Santiago (CL)

(72) Inventors: Cristian TAPIA VILLANEUVA, Santiago (CL); Lilian ABUGOCH JAMES, Santiago (CL); Nelson CARO FUENTES, Santiago (CL)

(21) Appl. No.: 16/074,585

(22) PCT Filed: Feb. 1, 2016
(86) PCT No.: PCT/CL2016/000004

§ 371 Date: Apr. 29, 2019

(51) Int. Cl. A23B 7/16; B65D 65/46; B65D 81/28; B65D 85/34; B41J 3/407

(52) U.S. Cl. CPC A23B 7/16; B65D 65/463; A23V 2002/00; B65D 85/34; B41J 3/407; B65D 81/28

(57) ABSTRACT

Edible Bio-Active Films Based On Chitosan Or A Mixture Of Quinoa Protein-Chitosan; Sheets Having Chitosan-Tripolyphoshate-Thymol Nanoparticles; Production Method; Bio-Packaging Comprising Same; And Use Thereof In Fresh Fruit With A Low PH.

This invention relates to bioactive edible films, a process for preparing them, use of said films, biopackaging process comprising said films, a process for forming biopackages, and use of said biopackages. Such films are made up high-molecular weight chitosan or a mixture of high molecular weight chitosan and an aqueous quinoa protein extract, extracted at pH 11, a material, as a sheet of printing paper being obtained, incorporating, via printing, a dispersion of nanoparticled antimicrobial agents having antimicrobial activity.

The purpose of the biopackages herein disclosed is to increase the shelf life of low-pH fruit, keeping it fresh, since the incorporation of nanoparticles into its composition makes it possible to water vapor permeability WVP of hydrophilic materials, provide a greater barrier to pathogenic microorganisms, and improve mechanical properties.

### BACKGROUND OF THE INVENTION

Consumption of fresh fruit and vegetables has been reported to be one of the major causes of contamination by pathogenic microorganisms and is closely related to outbreaks of enteric diseases associated with the consumption of these produce.

Colonization of fresh food by microorganisms constituting a risk to consumers may occur in the different processes along the production chain, its main focuses being agricultural soil, irrigation water and animal fertilizers. Foods may also be contaminated during harvest and in later stages because of handlers' hygiene and processing plant sanitation processing plant, causing the food cross-contamination phenomenon (Heaton et al., 2008).

Currently, several efforts have been made to generate new packaging materials being able to extend the shelf life of fresh food or of minimally processed food, provide consumer with safety by reducing outbreaks of foodborne illnesses, reduce significant losses for the productive sector, as well for them to be ecosystem friendly. A wide variety of materials have been tested to this effect, the most used being biopolymers, such as lipids, proteins, polysaccharides and mixtures thereof, to enhance the properties of films.

According to the prior art, 2032-14 is known to disclose a composition having antimicrobial capacity comprising chitosan, organic acids, fatty acids and additives.

Chilean application 2385-12 discloses edible mixtures to form preserving films for fruit containing aqueous protein quinoa solutions and lipids; a process of forming edible film; a process for manufacturing the edible mixture comprising mixing the aqueous protein quinoa solution with a lipid, and incorporating the chitosan solution; a process for applying the edible film comprising applying to fruit the edible film by immersion or spraying.

Document CN102743745 make reference to a controlled a controlled release hepatoma cell vaccine based on granulocyte-macrophage colony stimulating factor (GM-CSF) coated by chitosan nanoparticles.

Document CN103750565 disclosed a cigarette filter bar loaded with nanoparticuled chitosan and the method for preparing it.

Document DE102011085217 relates to a composition that is useful for hair treatment comprising the quinoa protein, a quaternary ammonium compound, such as a quaternary imidazoline and a fatty nutritional component comprising silicon and/or an oil.

Document CN 103275358 discloses a chitosan-based film composite and a method for preparing the coating containing said film.

The above described state of the art is very different in many ways, since none of these documents discloses any material or biodegradable film to be used as biopackaging, in that, one of its sides is printed with antimicrobial nanoparticles to form a package for storing fruit, as will be described further below.

Edible films (EF) correspond to polymer matrices and are defined as a thin layer of edible material providing a barrier against moisture, oxygen, CO₂ and the migration of smells and solutes from the food. The material may be an independent film or a sheet (or film).

This kind of materials has been thoroughly studied in recent years because of their advantages with respect the synthetic films, such as edibility and biocompatibility. As a result of their biodegradability, they are regarded as an alternative to reduce waste generation, since, even if not consumed, they degrade more easily readily than synthetic materials.

They may be made from different materials having film-making capacity. In general, they may be classified into three categories: hydrocolloids (such as proteins and polysaccharides), lipids (such as fatty acids, triglycerides and waxes), and composites of heterogeneous nature, consisting of a mixture of polysaccharides, proteins and/or lipids. The purpose of producing composite films is reducing water vapor permeability (WVP) of hydrophilic materials, and improving mechanical properties.

These heterogeneous films are applied as an emulsion, suspension, by dispersing the immiscible components in successive layers, or as a common solvent solution, and may be used for individual packaging of small portions of food, particularly of products that are currently packaged individually, such as pears, pecans and strawberries.

As stated above, our invention relates to films based on of composites of different nature consisting of a mixture of polysaccharides, proteins and/or lipids.

Polysaccharide-based films are able form edible films (EF), by themselves due to the linearity presented by their polymer chains, facilitating the interaction of functional groups with the solvent.

Polysaccharides having the capacity to generate films include: alginates, carrageenan, pectins, starches, gums, mucilage, chitosan and mixtures thereof, chitosan (Qo) standing out for its mechanical, physico-chemical and antimicrobial properties (AM).

Structurally, proteins are more complex than polysaccharides, since their structure may contain between 100 to 500 amino acid residues granting the ability to polypeptides to generate more kinds of intra- and intermolecular interactions that are more versatile. However, proteins cannot to generate EF by themselves, adding plasticizers, such as glycerol in high concentrations (3-63%) having to be added in general; otherwise, brittle and little manageable films are obtained.

Quinoa seed stands out among researched protein sources, as a result of its high protein content. Average protein content is between 12% to 17% (Ando et al., 2002; Karyotis et al., 2003; Abugoch et al., 2008). Quinoa's dry-base protein content (db) corresponds to 16.3%, which is significantly greater than such other grains as barley (11% db), rice (7.5% db), or corn (13.4% db), and is comparable to that of wheat (15.4% db).

The use of plasticizers in protein-based films shows greater elongation than polysaccharide-based films, and greater water vapor permeability (WVP).

As mentioned above, chitosan (Qo) is the polysaccharide that will be a part of the composition of edible biodegradable films to be reviewed. Qo (from the Greek “shell”) is a linear polysaccharide comprising (containing units 2-acetamido-2-deoxy-D-glucopyranose (N-acetylglucosamine) and 2-amino-2-deoxy-D-glucopiranose (N-glucosamine) attached by glycosidic linkages β (1→4) chains, having a with deacetylation degree not lower than 65% (Majeti and Kumar, 2000). It is a white, hard, inelastic and nitrogen polysaccharide. This substance was discovered in 1859. It may be used in agriculture as a fungicide, and in the wine making industry to prevent wine deterioration. In medicine, it is sometimes used as an additive in bandages used to reduce bleeding and lower the amount of infections.

Chitosan is commercially produced by chitin deacetylation, which is a structural element of the exoskeleton of crustaceans (crabs, shrimps, lobsters, etc.). The degree of deacetylation (DA) may be determined via NMR-H⁻¹ spectroscopy, or via Fourier transformed infrared spectroscopy (FTIR): in chitosans, said degree is within a 60-100% range.

The formula of chitosan is as follows:

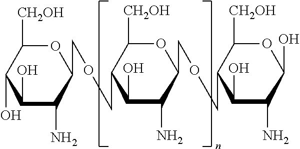

The amino group in chitosan has a pKa value of about 6.3, reason by which it has a slight positive charge and is soluble in acid or neutral solutions, depending on the pH load and DA value. That is, it is a bio adhesive and may bind to negatively charged surfaces, such as mucous membranes. As a result of this physical property, it allows the transportation of polar active ingredients through epithelial surfaces, and is also biocompatible and biodegradable.

Qo's molecular weight ranges from 100 to 1,500 kDa, where Qo's molecular weight values between 100 to 300 kDa are regarded as low, Qo's molecular weight between 300 and 600 kDa as medium, and a molecular weight above 600 kDa as high. In addition Qo is basic, as stated above, with a pKa of approximately 6.3. It is soluble in diluted organic and minerals acids. Qo's solubilization occurs via protonation of its free amino group in acidic environments and remains in a solution up to a pH being close to 6.2, after which it begins to form precipitates similar to hydrated gels.

Qo is a cationic copolymer that may be chemically modified in order to modify its physical and chemical properties. Chemical modification of the amino group and of the primary and secondary hydroxyls groups is possible. Possible derivatizations include its crosslinking, etherification, esterification and copolymerization (Lloyd et al., 1998). Given its versatility and biocompatibility, low toxicity, biodegradability and bioactivity, it has been used in a number of technological and biomedical applications, including tissue engineering.

Moreover, Qo abounds and it is a renewable and low cost material of ecological interest, hence the interest in its application in the food area.

Another known use for chitosan is a coadjuvant for plant growth because it allows to promote plant's defense against fungal infections. Its use has been approved by many indoor and outdoor plant growers. Given its low toxicity index and its abundance in the environment, it should not harm plants or pets, provided it is used in accordance with appropriate guidelines.

Chitosan (Qo) has the property to form films by itself, as a result of the linearity of its chain, wherein the cationic groups may establish intra- and interhydrogen-type bridges with the solvent.

It has been described that Qo films are biodegradable, biocompatible, flexible, long lasting, with firm and hard consistency, low flexibility and hard to break, having a very good oxygen barrier, moderate water vapor permeability values, in addition to antimicrobial (AM) activity against a wide spectrum of microorganisms.

Jeon et al, (2002) reports that films' shear tensile strength (STS) and elongation of films made from high molecular weight Qo are superior to those low molecular weight Qo. Qo films show high ETR values with respect to coatings made from other polymers, but have low and medium elongation values, since it forms orderly and compact structures in which molecules are very close to one another and leave little free volume. This characteristic is improved when plasticizers, mainly, or other components such as proteins and lipids, are added to the formulations.

As mentioned above, quinoa seed has a high protein concentration, which is beneficial for the production of films, quinoa protein reserve is mainly globular 11S and 2S albumin (Brinegar et al., 1996), just as those of other extracts or isolated proteins that have been used to prepare films such as soy protein (Cunningham et al., 2000). As for the general characteristics of this seed, it may be mentioned that, as compared to most grains, quinoa has a higher nutritional value; the seed's protein content ranges from 12 to 23% (Abugoch, 2009), mainly made up of albumins and globulins (44-77% total protein), and none or low prolamin (0.5 to 7%) and regarded as gluten-free (Jancurová et al., 2009). It has excellent essential amino acid balance due to a wider range of amino acids than grains and legumes, with high levels of lysine (5.1 to 6.4%) and methionine (0.4-1.0%) (Abugoch et al., 2008).

Studies of quinoa protein molecular structure allow to characterize storage protein 11S, called chenopodina, representing 37% of total proteins. Globulin 11S is a hexameric protein made up of six pairs of basic and acidic polypeptide subunits with 20-25 and 30-40 kDa molecular masses, respectively, each pair connected by a disulfide bridge (Brinegar and Goudan, 1993; Abugoch et al., 2008). Chenopodina has a high content of glutamine, glutamic acid, aspartic acid, asparagine, arginine, leucine, serine, and glycine. According to FAO's reference protein (US Department of Agriculture, 2005), chenopodine meets the requirements for leucine, isoleucine, phenylalanine and tyrosine. The other important protein (35% total protein) is a 2S (albumin) protein, which has a molecular mass of 9.8 kDa. This protein is cysteine, arginine and histidine-rich.

Such properties as elasticity, internal plasticity, hydrophilic characteristics of the thus formed edible film, which is able to form films without using plasticizers, discern this new composite as a suitable alternative for packaging fresh food. However, Qo's AM activity decreases when interacting with quinoa protein and, although adding proteins improves Qo film elongation, as it would be acting as a plasticizer, it, however, increases its water vapor permeability as a result of hydrophilic nature of these films.

It is because of the above that new techniques intended to modify the properties of these films are currently being tested, one of these strategies corresponding to incorporating lipid into films in order to reduce water vapor permeability (WVP), as reported by Valenzuela et al, (2013), where it was possible to decrease chitosan film WVP and quinoa protein extract (Qo/EPQ) up to 30% when adding high oleic sunflower oil at a 4.9% w/v concentration mixture.

A strategy that has been tried to reduce WVP is the incorporation of nanoparticles. Several studies have shown that the incorporation of nanoparticles into films generated from composites improves water vapor barrier properties and mechanical properties, since the added nanoparticles are restrained to the confined domains limited between polymer links forming the film. Further, the analysis at nanostructure level show that the dispersion of nanoparticles on films get aligned and interact with the matrix, which encumbers gas and water molecule diffusion through the film, creating a diffuse tortuosity effect on its path through the films.

Adding nanoparticles has been positively assessed in different matrices, such as hydroxypropylmethyl cellulose (HPMC), Qo, alginate, starch, among other polymers, in terms of WVP reduction (25% to 32%), depending on the kind of nanoparticle used, showing that the addition of nanoparticles in films exceeding the WVP reported for films containing oil.

The study of nanoparticles is completely multidisciplinary and the results of each research may be quickly applied to improve different characteristics in currently available products.

Nanocomposites generated and applied in formulations of different films may have different geometries, such as fibers, flakes, spheres or particles, representing a radical alternative in the development of new composites. This new generation of composites exhibit significant improvements in mechanical stability and solvent resistance regarding matrices without the incorporation of fillers at the nanoscale level.

Nanocomposites also offer additional benefits, such as low density, and transparency; they improve the properties of the surface, barrier and mechanics of films by using very low contents of filler, in general less than 5%.

The incorporation of nanoparticles helps to improve one of the main technological deficiencies of hydrocolloid-based films in terms of the ability to reduce permeability to water vapor, matching and/or exceeding the results obtained through the incorporation of oils.

Nanoparticles are frequently prepared through three methods: (1) dispersion of preformed polymers, (2) polymerization of monomers, and (3) ionic gelation or coacervation of hydrophilic polymers.

Qo nanoparticles have been described by ionic gelation using sodium tripolyphosphate (TPP), charged with silver ions showing a controlled and sustained release in the time of the agent.

The mechanism proposed for the formation of Qo-TPP nanoparticles suggests that ionotropic gelation of Qo occurs by electrostatic interactions between products of the dissociation of TPP in an aqueous solution ((P₃O₁₀)⁻⁵ y (HP₃O₁₀)⁻⁴), with the NH₃⁺ groups of Qo.

In general, it has been described that, by ionic gelation of Qo with TPP solutions, it is possible to obtain particles with sizes ranging from 100-350 nm usually showing a spherical morphology (Goycolea et al., 2009).

The advantage of this method lies in the use of fairly simple working conditions. It requires mixing two aqueous phases at room temperature, with moderate stirring, and avoids the use of organic solvents potentially toxic to cells and/or the stability of the agent to be encapsulated. Calvo et al. (1997) established the release of bovine serum albumin (BSA) from Qo-TPP nanoparticles. It emerged that the formation of the nanoparticles is generated using Qo solutions up to 4 mg/ml and TPP solutions of 0.75 mg/ml.

This technique offers advantages in many aspects, including increased precision and efficiency, flexibility in design of the release platform, cost savings, and lower consumption of raw materials and reagents. The efficiency of the mixing process and rapid chemical reaction to microliter or nanoliter scales provide microfluid systems with greater control of the process and, therefore, of the size and properties of the particles obtained (Hung and Phillip Lee, 2007).

Microfluid devices can be made of various materials depending on the applications; polymers, silicates and metals have been used for manufacturing.

Usually, through the use of micropumps, a pressure flow is generated in the microchannels; also, electrokinetic systems can provide other options for pumping liquids (Goycolea et al., 2009).

In the work of Yang et al., (2007), a cross-junction microfluid system was designed for the generation of Qo-TPP microparticles.

It was shown that the size of the particles generated can be controlled by changing the flow rate, and Qo-TPP microparticles can be obtained with homogeneous size.

There is background information on the addition of AM to films for food packaging in order to delay the growth of bacteria and fungi, by using this technique.

With respect to the use of nanotechnology as a system for delivery of agents, this technique has advantages in comparison to other systems, such as (a) easy manipulation of the size and surface characteristics of nanoparticles, (b) its ability to control and sustain the release of agents from the matrix to a particular place, time or condition, (c) the ability to control degradation and release of particles can be easily adjusted by choosing the constituents of the matrix, (d) the loading of agents can be relatively high, and they can be incorporated into systems without undesired chemical reactions.

Despite these advantages, nanoparticles have limitations, for example, their small size and large surface area can easily lead to aggregation of particles, making them difficult to manipulate, both in liquid and solid forms (Hung and Phillip Lee, 2007).

The incorporation of nanoparticulated active agents in the films will made using the thermal inkjet (TIJ) technique.

The thermal inkjet (TIJ) system achieves a controlled and precise printing dispersion and increased efficiency in the delivery of ink onto the material to be printed.

The TIJ system comprises a liquid container powered by vapor pressure wherein the printing head comprises a series of two fluid-filled chambers with a maximum volume of 30 ml. An electric pulse results in a rapid increase in temperature up to 300° C., which vaporizes some liquid cores, which then expands in a vapor bubble. As the bubble expands for a period of time ranging from 3 to 10 ρs (microsecond), the liquid is ejected from the chamber through the holes in the head at a speed of 10 m/s forming a microdroplet of about 180 pl (picolitre, which is one billionth of a liter). These dispersion parameters are optimized according to the physicochemical properties of the fluid (surface tension, viscosity and others).

In recent years, there have been various efforts to turn the thermal inkjet (TIJ) system into a versatile tool in several application areas, being considered as a key technology in the area where the deposit and binding of one or more molecules and/or polymers in a given matrix are required.

Recently, the use of thermal inkjet (TIJ) system by TIJ has been widely reported in the pharmaceutical area (Buanz et al, 2011; Melendez et al, 2008; Pardeike et al, 2011 and Scoutaris et al, 2011), mainly aimed at generating and delivering drugs in a customized manner according to the requirements of each patient, thus generating a revolution in the area of medicine and pharmacology by generating customized doses of a constant and controlled release from the containing matrix through TIJ technology called “printable medicine”, positioning this everyday technology beyond printing of simple documents and images.

This technology has not been reported in the area of food science and technology, appearing as an innovative strategy to generate active packaging by printing AM composites in coating films. It has been shown that films manufactured based on Qo and quinoa proteins have suitable physicochemical and mechanical properties to act as edible coatings of berries, however, it is necessary to improve their barrier properties and enhance its AM effect.

It is proposed that it is possible to add natural antimicrobial agents nanoencapsulated in this matrix by TIJ.

Most of the time, AM agents are added directly to food, but their activity can be inhibited by interactions with food, reducing their efficiency. In such cases, the use of AM films or coatings can be more efficient, because a selective and gradual migration can be designed from the packaging to the food surface, thus, a high concentration is maintained over time.

It is important to consider that AM bonded to polymers require to be active while bonded to the polymer. This activity is related to the mode of action; for example, if its mode of action is acting on the cell membrane or the microorganism wall, it is possible that AM acts, but it probably will not be the case if it is necessary, for the AM to act, that it enters the microorganism cytoplasm (Appendini and Hotchkiss, 2001).

There are no studies so far that report the AM activity of films manufactured based on quinoa proteins and Qo on food, with the incorporation of AM active ingredients into such films in particular, to evaluate their AM activity, of controlled AM release and increased shelf life of fresh fruits and vegetables.

As state above, Qo shows AM properties, and particularly antifungal properties, and its action has been proven at low doses against Botritys cinérea (Badawy and Rabea, 2009); on that basis, it is expected that quinoa-chitosan films maintain antifungal properties of Qo, but also the intention is to enhance this activity by incorporating nanoparticulated Qo in order to extend its AM action in time.

Furthermore, Hammer et al. (1999) evaluated the activity of 52 vegetable extracts and oils against different microorganisms, finding the lowest minimum inhibitory concentration for thyme essential oil (0.03% v/v). Omidbeygi et al. (2007) determined that main components of the thyme essential oil are thymol (33.14%), carvacrol (19.59%), linalool (16%), and cymene (10.3%), results consistent with other literature references.

At present, the FDA lists thymol, thyme essential oil and thyme (as a spice) as food for human consumption, and food additives.

As stated above, various natural AM agents have been evaluated and confronted to various pathogens and microorganisms which deteriorate fruits and vegetables, including, among others, thymol and Qo, due to the low concentrations required to inhibit the growth of both bacteria and fungi.

In the case of Qo with an approximate degree of deacetylation of 70% and a molecular mass of 500 kDa, it has been reported that the average minimum inhibitory concentration (MIC) for the strains of B. cinerea, E. coli, S. aureus and S. typhimurium corresponds to 15 ppm; this concentration of Qo inhibits proliferation after 18-24 h of incubation (Rabea et al., 2003).

Regarding thymol, this phenol has a wide action spectrum, just like Qo, against bacteria, fungi and yeast, and it has been reported a minimum inhibitory concentration (MIC) for S. aureus, Listeria innocua, E. coli and A. niger of 250 ppm, and in the case of S. cereviciae of 125 ppm (Guarda et al., 2011).

Therefore, we consider that these active agents, nanoparticulated Qo and thymol, incorporated by thermal inkjet in Qo and quinoa protein films, will be effective in controlling the proliferation of most significant pathogens in the area of fresh fruit, by controlled release of the agent from the matrix. We will evaluate their AM activity against Staphylococcus aureus, Escherichia coli, Pseudomona aeureginosa, Salmonella enterica serovar Typhimurium, Enterobacter aerogenes and Botrytis cinerea, expecting, to some extent, to enhance the AM activity of films and to improve the current technological deficiencies of these, such as the water vapor barrier properties, and to project their potential use as packaging material.

To better understand the invention, it will be described based on figures only of an illustrative nature, not limiting to the scope of the invention nor the aspects, nor the number of illustrated elements.

### BRIEF DESCRIPTION OF THE FIGURES

FIG. 1: Represents the transmission electron microscopy of NQoT suspension. (A) Dispersion of NQoT without the addition of glycerin and (B) Dispersion NQoT with 20% glycerin added, and sonicated for 15 min.

FIG. 2: Shows the mechanical properties of films with and without NQoT incorporated by 4 layers of thermal inkjet after 30 days under storage conditions (A) and (B) Chitosan/quinoa protein films and (C) and (D) Chitosan films. Different letters indicate significant differences (p<0.05). Significant differences indicate that there are statistical differences between the two samples of FIG. 2 at a probability level of 95% (p).

FIG. 3: Shows the FTIR spectrum of films (A) Qo and (B) control Qo/EPQ and with printed NQoT.

FIG. 4: Compares the effect of thymol (T) solutions, chitosan (QoLMW) solution, and film-forming solution (QoHV) on the minimum inhibitory concentration (MIC) required for all microorganisms (M.O) under study.

FIG. 5: Shows the area of growth inhibition (A) E. coli and (B) S. aureus against NQoT dispersion with and without addition of glycerol. Different letters indicate significant differences (p<0.05). Significant differences indicate that there are statistical differences between samples having different letters with a probability level of 95% (p).

FIG. 6: Shows the area of inhibition of bacterial growth of Qo films with NQo and NQoT incorporated by thermal inkjet, incubated for 3 h and 24 h at 37° C. Films were printed four times for each nanoparticle dispersion. Different letters indicate significant differences (p<0.05). Significant differences indicate that there are statistical differences between samples having different letters with a probability level of 95% (p).

FIG. 7: Shows the area of inhibition of bacterial growth of Qo/EPQ films with NQo and NQoT incorporated by thermal inkjet, incubated for 3 h and 24 h at 37° C. The films were printed four times for each nanoparticle dispersion. Different letters indicate significant differences (p<0.05). Significant differences indicate that there are statistical differences between samples having different letters with a probability level of 95% (p).

FIG. 8: Represents the inhibition of B. cinerea development. (A) Germination of viable spores against Qo and control Qo/EPQ films and with printed (inkjet) NQoT and NQo and (B) Comparison of the vegetative mycelial development of B. cinerea against NQoT, T, NQo, and mixture in QoLMW-T solution, all of them diluted to 10, 25 and 50% in the culture medium. Arrow (*) indicates no development.

### DETAILED DESCRIPTION OF THE INVENTION

Materials

1. Quinoa flour: Flour from organic quinoa seeds (Chenopodium quinoa Willd.), acquired from Cooperativa de Las Nieves, Region VI, Chile.

2. Chitosan (Qo): 2 types of Qo were used according to manufacturing requirements, films or nanoparticles, which are described below.

2.1. High viscosity chitosan (Qo): High viscosity chitosan from crabs (>400 mPa·s) (Qo) was used for manufacturing the films, with a degree of deacetylation of 75-85%. It was acquired from Sigma-Aldrich (crabs shells, Sigma, USA, C48165).

2.2. Low molecular weight chitosan (QoLMW): Qo 269 KDa (QoLW) was used in the manufacture of Qo (NQo) nanoparticles, with a degree of deacetylation of 75-85% (Sigma, USA, C448869).

3. Collection bacterial strains: Staphylococcus aureus ATCC 25923; Escherichia coli ATCC 25922; Pseudomonas aeruginosa ATCC 27853; enteric Salmonella serovar Typhimurium ATCC 14028; Enterobacter aerogenes ATCC 13048; Listeria innocua ATCC 33090. All strains were acquired from the Institute of Public Health (Santiago, Chile.). Additionally, filamentous fungus Botrytis cinerea wt was used, isolated from RedGlobe grapevines.

Preparation of Edible Biodegradable Films

1.—Preparation of the Film Base

1.1 Obtaining Quinoa Protein Extract

The methodology reported by Abugoch et al., (2011) and Valenzuela et al. (2013) was used. Protein extracts (EPQ) were prepared, using quinoa flour:water extraction proportions of 1:5 (18% p/p); once this suspension was obtained, pH was adjusted to 11 with NaOH 1M using pH meter (pH meter WTW pH330, Germany) They were kept under stirring for 60 min at room temperature, and then were centrifuged at 21.000×g for 30 min at 15° C. (HERMLE Z-323 Germany). The EPQ was prepared and used fresh whenever they were required. The content of soluble proteins (SP) in the extracts was determined according to Bradford (1976).

1.2. Preparation of Qo Solution.

Qo solutions were prepared in concentrations of 1.5 and 2.0% (p/v) dissolved in 0.1 M citric acid, dissolving with constant stirring for 24 h. The solutions were left to rest, refrigerated at 4° C. for 12 h, and then sonicated (Fisher Scientific FS30H, Argentina) for 30 min to remove bubbles. The solutions were stored at 4° C. until use.

1.3. Preparation of the Film Base

Chitosan films (Qo) were manufactured from a Qo solution (1.5% and 2.0% p/v in 0.1 mol/L citric acid), of a high molecular weight and high viscosity.

Films were obtained from 110.5±0.1 g of Qo solution (1.5 and 2.0% p/v) and by molding on low density polyethylene plates (diameter=14 cm), and then drying at 50° C. until reaching a constant weight. Hybrid films (Qo/EPQ) were prepared from mixtures of quinoa protein extract (EPQ), obtained at pH 11, and Qo solutions of a high molecular weight (1.5% and 2.0% p/v in 0.1 mol/L citric acid), using different proportions of both polymer solutions (90:10, 80:20, 70:30, 60:40 and 50:50% v/v). The same molding and drying process described for Qo films was used to obtain the films. Hybrid films Qo/EPQ were obtained from 148.5±0.1 g of the respective mixtures in Qo/EPQ solution. The time required to obtain the desired films ranged from 440 min for Qo films and up to 780 min for hybrid films Qo/EPQ.

2. Manufacture of Nanoparticles

2.1 Manufacture of Qo and Thymol (NQoT) Nanoparticles

Chitosan nanoparticles (NQo) with thymol (T) were prepared by ionotropic gelation with sodium tripolyphosphate (TPP) of technical grade, 85% (Sigma, USA, C238503). An aqueous solution of thymol (T) (Sigma, USA, CT0501) at 0.1% (p/v) was prepared in 0.1 M citric acid or 1% p/v acetic acid, to which low molecular weight chitosan (QoLMW) at 0.3% (p/v) was added, NQo without an agent were prepared from a solution of Qo 0.3% (p/v) in 0.1 M citric acid or 1% p/v acetic acid. The solutions were stirred for 24 h and then were filtered (Whatman No. 2 filter). Additionally, a TPP solution 0.1% (p/v) was prepared. NQoT solution was mixed with TPP was mixed in a 2:1 ratio by dripping (1.8 ml/min) using an infusion pump (model KDS200, KD Scientific©) under constant stirring. The obtained dispersion was centrifuged at 21.000×g at 14° C. for 30 min (Hermle centrifuge model Z32K). The NQoT concentration was 4.4±0.1 mg/mL. The characterization of NQoT and NQo was performed using the Zetasizer Nano ZS-90 equipment (Malvern Instruments©).

2.2 Preparation of NQoT Ink Dispersion

Glycerin was added to the prepared NQoT (4.4±0.1 mg/ml), in two concentrations of 20 and 30% (v/v), in order to modify the kinematic viscosity and surface tension. Each dispersion was sonicated for 30 min and stored at room temperature until characterization and use.

3 Characterization of Dispersions for NQo and NQoT Printing.

3.1 Determination of Kinematic Viscosity:

Determinations of the absolute viscosity of printing dispersions, hereinafter called “inks”, were measured using Ostwald viscometer, U-tube; viscosity was determined at 25° C. in a temperature-controlled bath (Grant Instruments Ltd., Cambridge, UK). Kinematic viscosity was calculated using the Stokes formula and expressed in mm²/s. (Buanz et al., 2011).

3.2 Determination of Surface Tension:

Surface tension was determined for 50 ml of each ink, measured by a microtensiometer (Kibron Inc., Finland). The surface tension pattern was compared against distilled water (surface tension=72.8 mN/m at 25° C.). (Buanz et al., 2011).

3.3 Determination of Size, Z Potential and Polydispersity Index:

For the characterization of NQoTh ink, surface charge and size were determined, this measurement was performed using the Zetasizer Nano ZS-90 equipment (Malvern Instruments). 1.0 ml was taken from the NQoTh suspension with 20 and 30% p/v of glycerol (also known as glycerin), respectively, and they were placed in a folded polystyrene capillary tray (model s90); the analyses in the equipment were performed under standard conditions (dispersant: water, T: 25° C., laser 633 nm).

3.4 Transmission Electron Microscopy (TEM):

To determine the size of NQoT, in addition to the measurements in Zetasizer, TEM was used, for which they were analyzed in a copper grid (SPI Supplies, Inc., West Chester, Pa., USA) in a Philips Tecnai 12 Bio Twin equipment.

3.5.—Contact Angle:

For each dispersion of agents, contact angles on the surface of Qo films and Qo/EPQ films were measured at room temperature (20° C.), by means of an optical system, comprising a zoom video (Edmund Optics, NJ, USA) connected to a CCD camera (Pulnix Inc., San Jose, Calif., USA) operated through the Coyote program. Drops of an approximate 2 μl volume were manually placed with a micropipette (Gilson Pipetman U2). The apparent contact angle (angle between the tangent plane to the liquid surface and the tangent plane to the film) was determined using the ImageJ program (National Institutes of Health, USA) with the Drop Shape Analysis plug-in (Drop-analysis, 2011). The contact angle measurements were made within 30 s after placing the drop on the film, to neglect the effect of evaporation. Contact angle measurements were made in 10 drops.

4. Modification of the Cartridge and Determination of Printing Conditions:

All experiments were performed using the Hewlett-Packard printer, model 4000k210 (Hewlett-Packard Inc.), which uses “drop-on-demand” (DOD) technology, by means of thermal inkjet (TIJ) system. Only modified black ink cartridges (HP 675, cn690A) were used for the printing process, which was modified by cutting the upper part and removing the sponge pad inside, it was rinsed 3 times with distilled water and then acetone.

Heads were loaded with 20 ml of each ink dispersion. For the printing of both types of inks on the Qo and Qo/EPQ films, the printing tempering was prepared using a geometrical figure designed in Office World 2007 (Microsoft Inc.), this figure was a square with physical dimensions of 8.8×8.8 cm, equivalent to a printing area of 77.44 cm2. The printing parameters were the selection of black ink color and a maximum resolution of 600 dpi, which allows a delivery volume per drop of 180 pl (Hewlett-Packard Inc. Pagewidetechnology). Buanz et al., (2011)

5. Microbiological Trials

5.1 Determination of the Minimum Inhibitory Concentration (MIC):

To evaluate the antimicrobial capacity of the ink prepared from the NQoT dispersion, the minimum concentration that is able to inhibit the visible development of the bacterial strains S. aureus; E. coli; P. aeruginosa; S. typhimurium; E. aerogenes and L. innocua in a liquid culture medium (trypticase soy broth), after 24 h incubation, was determined. Bacterial strains were obtained from an isolated colony on a selective and differential agar plate for each genus, and were inoculated in nutritious broth for 24 h at 37° C. with stirring until obtaining a saturated culture. Then, the desired concentration of microorganisms was determined, in comparison with the standard of McFarland 0.5, and the corresponding dilutions were made in order to reach a concentration of 1×10⁵ CFU/ml (colony-forming units/ml). To each culture tube, agents in serial dilutions were added, and incubated at 37° C. for 24 h; then, the lowest concentration of the mixture capable of inhibiting bacterial growth, given by absence of turbidity in the culture medium, was determined. The solutions used to generate the Nps and nanoparticles without T in their formulation (NQo) were used as controls.

5.2 Determination of the Growth Inhibition Area:

The dissemination trial was performed based on the standard method described in the literature (Sambrook et al., 1989, Bauer et al., 1966). Each bacterial strain was seeded on grass in Müller-Hinton agar. Printed films were cut into a 6 mm² disc obtaining a printed volume of 0.072 mm³, where the T concentration was 3.0 μg/mm³ for the film printed with NQoT, and 3.5 μg/mm³ for the film printed with the T solution. As controls, 10 μl of each stock solution was loaded onto a 6.0 mm² sterile filter paper disk with a thickness of 0.65 mm, as described by Sambrook et al., (1989), concentrations in the disk for the stock solutions of QoLMW were 30 μg and 0.06 μg for the T solution. After incubation, the generated inhibition halo was determined and the area of inhibition is expressed in mm².

5.3 Preparing Botrytis cinerea Inocula and Obtaining Spores:

The fungus was grown on the surface of potato dextrose agar until abundant mycelium development was observed (approximately 5 days at 25° C.); from this culture, spores were obtained with the help of a Drigalsky rod, then they were suspended in a flask with 0.1% p/v peptone water, also adding glass beads. It was stirred and then filtered through hydrophilic cotton to retain the mycelium and, thus, obtain the suspension of spores. Using the Petroff-Hauser chamber, their concentration was determined, and they were diluted when necessary until obtaining a concentration of 1.0×10² spores/ml.

5.4 Inhibition of Botrytis cinerea Mycelium:

The antifungal activity of the NQoT dispersion was evaluated by inhibiting the radial development in the fungus mycelial plate, described by Yildirim et al., (2007). For that purpose, a portion of mycelium was sterilely taken, using a punch, from a strain previously cultivated for 5 days at 25° C., which was placed in the center of a potato dextrose agar plate mixed with dilutions of the NQoT dispersion until obtaining in the agar concentrations of 0.44 mg/ml (dispersion diluted to 10% v/v), 1.1 mg/ml (dispersion diluted to 25% v/v) and 2.2 mg/ml (dispersion diluted to 50% v/v). These plates were incubated for 6 days at 25° C., being evaluated every 24 h. The antifungal activity was determined through the mycelium propagation area of the plates containing NQoT, and were compared with agar plates containing T solutions, mixture of QoLMW-T, and the NQo dispersion in the same dilutions, and a culture of the fungus seeded in a plate without treatment, whose propagation on the surface of the plate (8.5 cm2) is equivalent to a 100% development, which was used as a parameter of growth comparison.

5.5 Inhibition of Botrytis cinerea Spore Germination:

The Qo and Qo/EPQ films printed 4 times with NQoT were placed in an Erlenmeyer flask which contained a B. cinerea spore suspension at a concentration of 1.0×10² spores/ml in Sabouraud-Dextrose broth, and incubated with stirring at 25±0.1° C. for 5 days. Each day, an inoculum of 1.0 ml was taken and seeded in depth on plates with Sabouraud agar, subsequently incubating them at 25±0.1° C. for 5 days, thus, determining the germination count. Unprinted Qo and Qo/EPQ films and Qo and Qo/EPQ films printed with NQo were used as a comparison parameter.

6. Characterization of the Suspension of Chitosan-Thymol (NQoT) Nanoparticles to be Printed on Films.

Table 1 shows the results of the physicochemical properties (kinematic viscosity and surface tension), Z potential, particle size (Z-average) and polydispersity index (PDI) of NQoT dispersion after the addition of 20 and 30% (v/v) glycerin to the formulation. The values of kinematic viscosity (U) of the NQoT dispersion without added glycerin show a U of 1.1±0.0 (mm2/s), which is very similar to the values reported for distilled water. The U values of the dispersion increase significantly in relation to added glycerin, 1.5±0.0 and 2.3±0.0 (mm2/s) with 20 and 30% v/v, respectively; this increase occurs because glycerin increases cohesion forces of the dispersion, reducing the flow speed gradient. With respect to surface tension values (γ) of the dispersion without glycerin (73.2±0.0 mN/m), it is slightly higher than the value reported for distilled water (72.8 mN/m), which indicates that NQoT interact intermolecularly with the water that contains them, increasing the resistance of the dispersion to increase the surface (Kipphan, 2001). After the addition of 20 and 30% v/v glycerin, the γ of the dispersion reduces to 49.3±0.0 and 53.1±0.3 mN/m, respectively, because glycerin, being a surfactant, increases the density of the dispersion and modifies the water-NQoT-water interface, affecting the physical space for the interaction between water and NQoT, increasing the NQoT solubility. Therefore, in aqueous solution, the NQoT disseminate towards the air-liquid interface and are preferably absorbed at the surface, which reduces the γ of the dispersion. By adding 20% v/v glycerin, values of γ (49.3±0.1 mN/m) and U (1.5±0.0 mm²/s) were obtained which are similar to those reported by Gans et al., (2004) and Khan et al., (2010) for commercial ink solutions (γ=47.5 mN/m and U=1.3 mm²/s), which helps to ensure a fast replacement of the liquid created by the vacuum at the time of printing, preventing the dripping of the head to avoid over-wetting the printed matrix.

TABLE 1
Effect of glycerin on the physicochemical properties, Z potential,
particle size and PDI of the suspension of chitosan-thymol
nanoparticles. Different letters indicate significant differences
(p < 0.05). Significant differences indicate that there
are statistical differences between the samples having different
letters with a probability level of 95% (p).

| Added | Kinematic | Surface | | Variation in | |
|---|---|---|---|---|---|
| glycerin | viscosity | tension | Z potential | particle size | |
| (% v/v) | (mm²/s) | (mN/m) | (mV) | (nm) | PDI |
| 0 | 1.1 ± 0.0 | 73.2 ± 0.0 | 49.9 ± 2.3 | 310.4 ± 69.6 | 0.41 ± 0.0 |
| 20 | 1.5 ± 0.0 | 49.3 ± 0.1 | 42.1 ± 4.8 | 383.8 ± 58.7 | 0.46 ± 0.0 |
| 30 | 2.3 ± 0.0 | 53.1 ± 0.3 | 37.3 ± 2.7 | 417.4 ± 53.1 | 0.55 ± 0.0 |

Table 1 also shows the effect of the addition of glycerin (20 and 30% v/v) on the properties of the NQoT dispersion, which were evaluated through size variation and zeta potential of the nanoparticles, in relation to the values of the NQoT dispersion without glycerin.

The NQoT dispersion with 20% (v/v) glycerin showed a Z potential significantly higher when compared with NQoT with 30% (v/v) glycerin, (42.1 mV±4.84 and 37.3 mV 2.71, respectively), while PDI increased approximately 25% with the addition of 30% (v/v) glycerin, from 0.46±0.0 to 0.55±0.0. Size variation with the addition of 30% p/v glycerin increased by 25% (417.36±53.12 nm), in relation to 20% glycerin (p/v) (383.83±58, 76 nm). The variation of these parameters, compared with the values for the dispersion without glycerin, is because glycerin, when interacting with particles in solution, would shield the surface electrical charges, which reduces the Z potential; in addition, it also reduces electrostatic repulsion between them, thus, causing agglomeration, increasing size and polydispersity index of the particles; in addition, the presence of glycerin in a nanoparticles solution induces coalescence between particles (Khoee et al., 2012). It has been described by Müller et al., (2001), that nanoparticles with potentials above +30 mV and PDI below 0.7 are stable and functional, thus, the addition of glycerin, in the range under study, does not affect the stability of the NQoT.

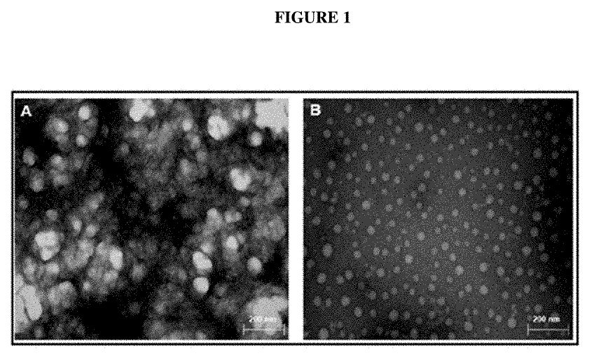

Additionally, the size was determined by transmission electron microscopy (TEM). FIG. 1 shows the microphotographs of the NQoT without the addition of glycerin (FIG. 1A) and with the addition of 20% glycerin (FIG. 1B), after subjecting the sample to ultrasound for 15 min. The dispersing and ordering effect that glycerin provides to the NQoT in solution is observed, helping to obtain Nps of a clearly defined and isolated geometry, compared with the NQoT present in the dispersion without glycerin.

When comparing the size results of the Nps obtained by TEM and DSL (Table 1), a clear difference is observed between the obtained values, where in values obtained by DSL, sizes are almost 10 times higher than those obtained by TEM (particles between 30 and 60 nm). The great difference shown by both techniques is that, in the case of TEM, a direct microscopic measurement of the dehydrated sample is made while the Zetasizer Nano ZS-90 equipment determines the size associated with the movement of the particles in solution (Brownian movement), thus determining the hydrodynamic diameter (size variation) of Nps (Akbari et al., 2011).

7. Mechanical Properties and WVP of Films with NQoT in Cold Storage Chamber.

7.1 Effect of Printed NQoT on the Mechanical Properties of Films Under Conditions of Cold Chamber Storage.

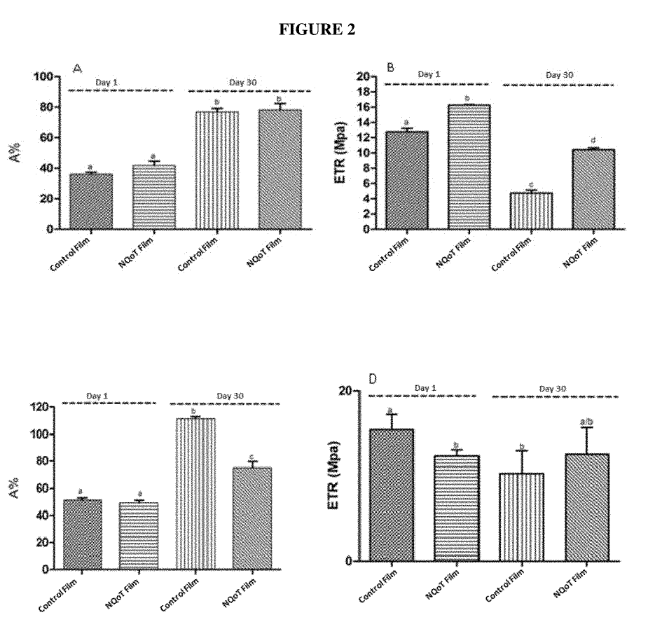

Mechanical properties of films with 4 layers of NQoT printing were measured before and after subjecting them to cold storage conditions (85% HR and 0° C.), these results are shown in FIG. 2.

Cold chamber storage for 30 days significantly increases elasticity (A %) and significantly reduces mechanical resistance (ETR), which agrees with the uptake of water under this condition (85% H.R) and its consequent hydrating effect on the film.

For the case of Qo/EPQ films, no significant differences were found in elasticity (A %) between the films with and without NQoT (FIG. 2A), both in the non-storage condition (36.1±1.3 vs. 41.8±2.1) and in the 30-day storage condition (76.9±2.2 vs. 78.2±4.2). On the other hand, in FIG. 2B, a significant increase in mechanical resistance (ETR) is observed when NQoT are incorporated, with (12.7±0.5 vs. 16.3±0.1) or without storage (4.7±0.3 vs. 10.4±0.2). For the case of Qo films (FIG. 2C), it is found that, without storage, there are no elasticity differences between films with and without NQoT (51.3±1.7 vs. 49.2±2.0), but, unlike Qo/EPQ films, the incorporation of NQoT reduces mechanical resistance (15.4±1.7 vs. 12.3±0.8), which is observed in FIG. 2D. In the storage condition, films without NQoT are 32% more elastic (111.0±3.6 vs. 75.1±4.7), but their mechanical resistance does not differ significantly in relation to those with Nps incorporated (10.2±2.7 vs. 12.5±3.2). If the effect of storage on both films is evaluated, it is found that elasticity is significantly increased, but mechanical resistance reduces only in the films without NQoT. For the case of Qo/EPQ films, heterogeneity and porosity of these films allow the nanoparticulated Qo to act as a filler at a structural level, which is evident in the increase in mechanical resistance and elasticity when compared to films without these Nps. In contrast, Qo films have an absolutely heterogeneous and compact microstructure, thus, printed NQoT are arranged superficially in this matrix, which does not significantly affect the ETR, unlike elasticity, since the nanoparticulated Qo would act as a reinforcement of the structure of these films.

7.2 Effect of Printed NQoT on the Water Vapor Barrier Properties of Films Under Cold Chamber Storage Conditions.

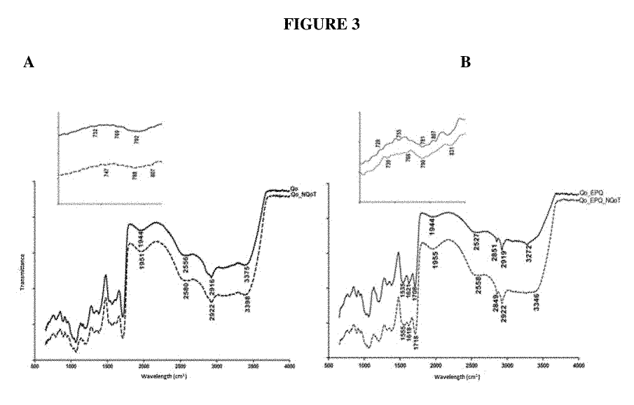

As stated above, films with application in fruits require a degree of hydrophobicity to avoid loss of moisture during storage and, thus, increase their post-harvest shelf life. The results obtained from WVP for Qo and Qo/EPQ control films of this paper show water vapor barrier values higher than those reported by Abugoch et al., (2011) and Valenzuela et al., (2013), however, both types of films show low water vapor barrier values in comparison to materials manufactured from oil derivatives, such as low density polyethylene (LDPE), vinyl polychloride (PVC) or polypropylene (PP), which show water vapor permeability levels lower than 0.1×10⁷ g mm h⁻¹ m⁻² Pa⁻¹ (Han, 2014), because these films (Qo and Qo/EPQ) are structurally stabilized by hydrogen bonds, which makes them hydrophilic, as evidenced by the FTIR analysis (FIG. 3) (Abugoch et al., 2011, Valenzuela et al., 2013).

It has been reported that it is possible to reduce WVP of this type of films up to 30% when adding high oleic sunflower oil in a concentration of 4.9% (p/v) to the mixture, however, it drastically reduces mechanical resistance (ETR) between 90-95%, while elasticity (A %) reduces up to 80% (Valenzuela et al., 2013)

These disadvantages in the development of materials for the purpose of fruit packing are not beneficial, thus, it is necessary to develop another strategy for this purpose, which accounts for the incorporation of Nps, which have been described as improving the water vapor barrier properties in hydrophilic films, without affecting the mechanical properties (Clapper et al., 2008: Adame and Bael, 2009).

TABLE 2
Water vapor permeability (WVP) of Qo and Qo/EPQ films printed
with NQoT at 0° C. and 85% HR. Different letters indicate
significant differences. Significant differences indicate that
there are statistical differences between the samples having
different letters with a probability level of 95% (p).

| | Type of film | | | |
|---|---|---|---|---|
| | | Qo + NQoT | Qo/EPQ | Qo/EPQ + NQoT |
| | Qo film | film | film | film |
| PVA* | 3.0 × | 2.0 × | 3.0 × | 2.6 × |
| | 10^{-3a} ± 0.0 | 10^{-3b} ± 0.0 | 10^{-3a} ± 0.0 | 10^{-3b} ± 0.0 |

*g mm h⁻¹ m⁻² Pa⁻¹
^{a}3.0 × 10⁻³ is the scientific notation of the value 0.003;
^{b}2.0 × 10⁻³ is the scientific notation of the value 0.002; and 2.6 × 10⁻³ is the scientific notation of the value 0.0026.

Table 2 shows the results obtained for water vapor permeability (WVP), at 85% HR and at 0° C., of the Qo and Qo/EPQ films printed with the NQoT dispersion with 20% (v/v) added glycerin.

WVP of both films without Nps does not show any significant differences in this parameter (p>0.05); while, after the incorporation of 4 layers of Nps by printing, this value decreases 33.3% (3.0×10⁻³±0.0 to 2.0×10⁻³±0.0 g mm h⁻¹ m² Pa⁻¹) for Qo films and 13.3% for hybrid films (3.0×10⁻³±0.0 up to 2.6×10⁻³±0.0).

The decrease in WVP shown when incorporating NQoT in both films can be attributed, on the one hand, to the formation of a tortuous path for the dissemination of water vapor (Duncan, 2011). By this concept, gas molecules would have to pass through channels formed by the nanoparticles interleaved in the polymeric matrix, instead of directly passing through the polymer perpendicularly. Thus, the tortuous path would increase the average length of dissemination of water vapor (Duncan, 2011). On the other hand, when incorporating Nps into the films, the structure of the composite could be changed in the interfacial regions (Duncan, 2011). This could occur due to the formation of hydrogen bonds between Nps, the Qo interface, and polar radicals of the amino acids making up the structure of the quinoa proteins. Therefore, polymer strands in close contact with Nps could be partially immobilized and, thus, reduce the free volume of holes, their density and size, making the passage of vapor molecules through the nanocomposite difficult (Duncan, 2011). Decrease in the WVP value due to the incorporation of nanoparticles is consistent with that indicated by several authors. Thus, Medina (2013), who worked with chitosan-aqueous quinoa protein extract films, could reduce WVP to a maximum 19% when loading films to 5% of chitosan-tripolyphosphate nanoparticles produced by the ionotropic gelation technique. Similarly, Save (2011) showed a decrease in WVP equivalent to 9% when working with the same type of nanoparticles at a concentration of 1% using the same polymer matrix as Medina (2014).

It is believed that the increase in the WVP value when films are subjected to 0° C. is due to the increase in the water vapor pressure that is generated at a high HR (Wiles et al., 2000; Phan The et al., 2009). This would cause a greater adsorption of water molecules by polar molecules making up the films, thus generating their swelling and tumefaction. Therefore, a conformational change would occur in the microstructure of films, which would separate the polymer structure allowing an increase in the permeable flow of water vapor (Valenzuela et al., 2013). It is believed that, due to this phenomenon, the use of nanoparticles was more efficient for films conditioned at 0° C. compared to 23° C. (51% maximum reduction of WVP versus 18%, respectively); since separations and empty spaces that could be formed due to swelling and tumefaction could be covered by the nanoparticles.

8. Antimicrobial Activity.

8.1 Minimum Bacterial and Fungal Inhibitory Concentration in the Solutions Used in Manufacturing Nanoparticles and Film-Forming Solutions.

Table 3 shows the results of minimum inhibitory concentration (MIC) in T solutions and low molecular weight Qo solutions (QoLMW) used to generate NQoT dispersion. The Qo film-forming solutions, as well as the mixture between Qpo and EQP, at a 90:10 (v/v) ratio, with respect to microorganisms (MO) of this invention were also tested

TABLE 3
Minimum inhibitory of the active agents against the microorganisms used in this work.

| | Microorganism | | | | | | |
|---|---|---|---|---|---|---|---|
| Antimicrobial | S. | E. | E. | L. | Ps. | S. | B. |
| agent | Tiphymurium | coli | aerogenes | innocua | aeruginosa | aureus | cinerea |
| Timol (gL⁻¹) | 0.250 | 0.250 | 0.250 | 0.275 | 0.225 | 0.275 | 0.550 |
| QoLMW(gL⁻¹) | 1.0 | 1.0 | 1.0 | 0.8 | 1.0 | 1.0 | 2.5 |
| Qo (gL⁻¹) | 7.5 | 7.5 | 8.0 | 7.5 | 9.0 | 8.5 | 10.5 |
| Qo/EPQ (%)* | 90 | 90 | 90 | 100 | ND** | 100 | ND** |

*From the film generating stock solution;
**ND: Not detected

MIC values for the T solution in Gram negative bacteria was 0.250 g/l for S. tiphymurium, and E. coli, and 0.225 g/l for P. aeruginosa. As to Gram positive bacteria (L. innocua and S. aureus), it was 0.275 g/l. These values show Gram positive MO moderate resistance with respect to Gram negative bacteria. These concentrations are close to those as previously reported by Guarda et al., (2011).

As regards B. cinerea fungus, the concentration required to inhibit its growth was about 2 times higher than that of both kinds of bacteria (0.550 g/1).

As for the CIM values of the QoLMW solution, there is no difference in the concentrations required to inhibit the proliferation of Gram positive and Gram negative bacteria (1.0 g/1), except for L. innocua, which is inhibited with a lower concentration, 20% (0.8 g/1), showing greater sensitivity to QoLMW.

Just as observed for the T solution T, B. cinerea requires a higher concentration than the bacteria (2.5 g/1) to be inhibited.

The required inhibitory concentration in the Qo film-forming solution was 7.5 g/l to inhibit S. tiphymurium, E. coli and L. innocua, and 8.0, 8.5 and 9.0 g/l to inhibit E. aerogenes, S. aureus and P. aeruginosa's growth, respectively. B. cinerea requires a concentration about 1.5 times greater than Qo's film-forming solution to observe an effect on its inhibition with respect to bacteria. The CIM in the film-forming solution is about 85% greater than the concentration of the QoLMW solution in all of the tested bacteria. Qo's molecular mass is closely related to its AM capacity, this characteristic being one of the most relevant ones. Studies show that AM activity decreases significantly, up to 95% as Qo having a higher molecular weight is used (Dutta et al, 2009).

As regards the Qo/EPQ mixture, it is apparent that the presence of EPQ decreases Qo's AM activity by 90 to 100%. This is in line with what is reported by Rabea et al., (2003), who indicate that Qo's AM activity is inhibited when combined with proteins.

The results from the MIC show that, except for the solution containing the Qo and quinoa proteins mixture, has the capacity to limit cell growth of the MO studied. In addition, of all the solutions tested, the T solution was the one showing greatest effectiveness in inhibiting the proliferation of all the MO tested, when compared to the QoLMW solution, the Qo solution, and the mixture of this Qo with quinoa proteins, since lower concentrations that in the other solutions are required.

The results from the MIC of both film-forming solutions ratify the objective of boosting the AM activity of the Qo films and Qo/EPQ films by using NQoT.

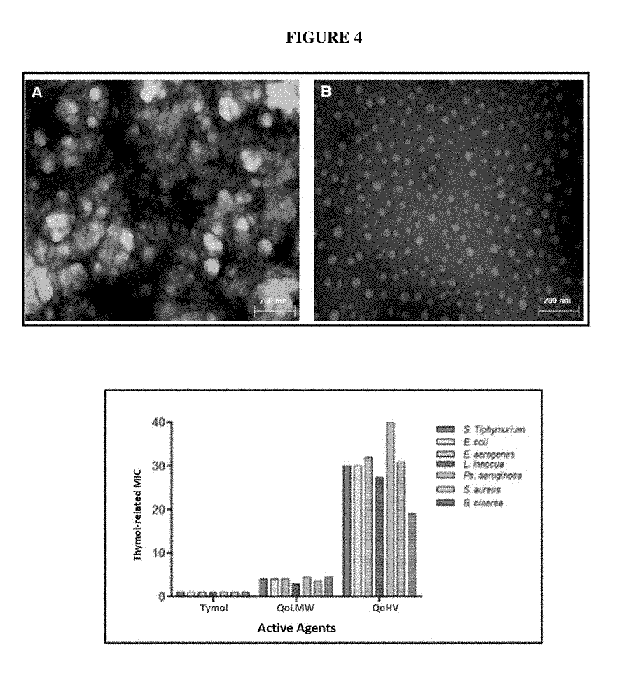

T's strong effect on inhibiting the growth of all of the MO studied is shown in FIG. 4, where the MIC of all the solutions is analyzed based on the inhibitory concentrations of the T solution. It is observed that a QoLMW concentration of approximately 4 times greater, and about 30 times higher than the Qo film-forming solution is required to achieve T's same inhibitory effect.

This effect difference is due to the mechanisms of action of each of these molecules (Qo and T) when confronting bacterial and/or fungal cells. Different mechanisms of action have been proposed to explain the effect of the Qo molecule on both bacteria and fungi. In bacteria, the Qo molecule could exert its biocidal effect mediated by three mechanisms, which would involve:

Qo could penetrate into the inside of the MO cell, blocking the bacterial chromosomal DNA's replication and transcription (Rabea et al., 2003);

b) Qo, when adsorbed into the microbial surface, would precipitate as a result of the acid-base properties of phosphatidylcholine, phosphatidylglycerol and cardiolipin, main components of cell membranes, which grant their neutral pH. This Qo precipitate would form a physical barrier, which would cause a blockage of the solute transport channels, such as porins (Qin et al., 2006); and

Qo would act as a chelator of certain metals, such as Mg⁺² and K⁺¹, as required as prosthetic groups or cofactors of enzymes involved in bacterium energy metabolism (Roller and Covill, 1999).

As regards filamentous fungi, such as B. cinerea, the mechanisms proposed for Qo include deletion and negative regulation in the gene expression being concomitant of the decrease in the rate of metabolic processes; biological membrane integrity disruption (Marquez et al., 2013). Additionally, Rui and Hahn, (2007), have reported that Qo may competitively inhibit the enzymatic activity of Botrytis hexokinase, blocking the first step of glucose metabolism.

As for T's biocide mechanism, it has been reported that, after 30 minutes at sublethal concentrations, this treatment is sufficient to cause negative effects on prokaryotic cell viability (La Storia et al., 2011).

T, when interacting on the microbial cell-surface, due to its lipophilic nature, would allow it to intercalate in the membrane, modifying the barrier structure and its resulting alteration of permeability and osmolarity, triggering swift and irreversible exit of cell components.

Further, enzymatic complexes being responsible for MO electron transport chain are affected, resulting in ATP's synthesis inhibition. On the other hand, Braga et al. (2012), have reported that T is able to inhibit the formation of lax glycocalix (“slime”), reason by which it would inhibit the formation of bacterial biofilms. AM mechanisms of action are attributed to the differences of effects as observed in this study.

8.2 Efficiency in Bacterial Inhibition of NQoT Dispersion

In order to assess AM efficiency of the NQoT dispersion, its effectiveness in serial dilutions was compared to dilutions of the stock solution in the QoLMW and T mixture A used to manufacture the NQoT and to Qo's Nps dispersion in its formulation lacking T (NQo). These results are shown in Table 4.

TABLE 4
Minimum concentrations (%) required to inhibit the
growth of microbial strains used in this study.

| | Microorganism | | | | | |
|---|---|---|---|---|---|---|
| Antimicrobial | S. | E. | E. | L. | Ps. | S. |
| agent | Tiphymurium | coli | aerogenes | innocua | aeruginosa | aureus |
| NQoT | | | | | | |
| 100% | − | − | − | − | − | − |
| 90% | − | − | − | − | − | − |
| 80% | − | − | − | − | − | − |
| 70% | − | − | − | − | − | − |
| 60% | − | − | − | − | − | − |
| 50% | − | − | − | − | − | − |
| 40% | − | − | − | − | − | − |
| 30% | − | − | − | + | + | + |
| 20% | + | + | + | + | + | + |
| 10% | | | | | | |
| NQo | | | | | | |
| 100% | − | − | − | − | − | − |
| 90% | − | − | − | − | − | − |
| 80% | − | − | − | − | − | − |
| 70% | − | − | − | − | − | − |
| 60% | − | − | − | − | + | + |
| 50% | − | − | − | + | + | + |
| 40% | + | − | + | + | + | + |
| 30% | + | + | + | + | + | + |
| 20% | + | + | + | + | + | + |
| 10% | | | | | | |
| Stock | | | | | | |
| QoLMW−T | − | − | − | − | − | − |
| 100% | − | − | − | − | − | − |
| 90% | − | − | − | − | − | − |
| 80% | − | − | − | − | − | − |
| 70% | − | − | − | − | − | − |
| 60% | − | − | − | − | − | − |
| 50% | + | + | − | + | + | + |
| 40% | + | + | + | + | + | + |
| 30% | + | + | + | + | + | + |
| 20% | | | | | | |
| 10% | | | | | | |

−No bacterial growth;
+bacterial growth. Growth is verified by medium turbidity. Each assay was performed in triplicate, in 3 independent experiments.

The results show that NQoT dispersion may affect viability of Gram negative bacteria Salmonella tiphymurium, Escherichia coli and Enterobacter aerogenes from 20% of the initial concentration, whereas, in order to obtain same inhibitory effect on these bacteria, the control dilutions must be 30% and 40% from the initial concentration. A similar effect was observed for Gram positive Listeria innocua and Staphylococcus aureus strains, where the NQoT's dispersion effect starts to inhibit proliferation as of 30% dilutions from the initial concentration, while the control solutions inhibit these bacteria as of 50 and 60% dilutions.

In all of the MO analyzed, the NQoT shows a strong inhibitory effect with respect to the control solutions, since it is able to inhibit microbial growth at diluted concentrations.

In this regard, NQo's AM activity, of a 115.5 mn size, as generated via ionotropic gelation, with TPP, was tested from a 440-kDa Qo solution at 1.0% w/v, against Staphylococcus aureus. This NQo may decrease the Qo concentration required to inhibit the growth of this bacterium by 50% when compared to the concentration of Qo without nanoparticulate.

8.3 Synergy in AM Activity of NQoT Dispersion

To define the kind of effect as observed by the NQoT on the MO studied (synergistic or by adding components), a theoretical calculation of the CIM was made based on the results obtained from the MIC (Table 3), and was compared to the experimental MIC as determined from the concentration of the components in a solution as required for preparing the NQoT (75% QoLMW and 25% T), as described by Medina (2014), and the results obtained in the inhibition efficiency test from the NQoT dispersion delusions (Table 4). The results are shown in Table 5.

TABLE 5
Quantitative assessment of the synergistic or
additive effect of NQoT dispersion and Qo-T
stock solution on the microorganisms used in this study.

| | Formulation | | | | | |
|---|---|---|---|---|---|---|
| | | | | Stock solution | | |
| | NQoT dispersion | | | mixture QoLMW-T | | |
| | Theo- | Experi- | | Theo- | Experi- | Effect |
| | retical | mental | Effect | retical | mental | dif- |
| Micro- | CIM | CIM | difference | CIM | CIM | ference |
| organism | (gL⁻¹) | (gL⁻¹) | (%) | (gL⁻¹) | (gL⁻¹) | (%) |
| S. | 0.813 | 0.334 | 58.92 | 125.0 | 106.8 | 14.56 |
| Typhimurium | | | | | | |
| E. coli | 0.813 | 0.334 | 58.92 | 125.0 | 106.8 | 14.56 |
| E. aerogenes | 0.813 | 0.334 | 58.92 | 125.0 | 80.1 | 39.92 |
| Ps. Aeruginosa | 0.806 | 0.500 | 37.96 | 122.5 | 106.8 | 12.81 |
| L. innocua | 0.819 | 0.500 | 38.94 | 107.5 | 106.8 | 1.39 |
| S. aureus | 0.819 | 0.500 | 38.94 | 128.5 | 106.8 | 16.88 |

As for Gram negative S. typhimurium, E. coli and E. aerogenes, a theoretical MIC was obtained from the NQoT dispersion and from the QoLMW-T mixture solution, 0.813 g/l and 125.0 g/l, respectively, whereas the experimental MIC, as obtained for these bacteria from the NQoT dispersion, was 0.334 g/l, and the mixture in a solution of QoLMW-T was 106.8 g/l for S. typhimurium and E. coli, whereas it was 80.1 g/l for E. aerogenes. The theoretical MIC for Ps. Aeruginosa, as obtained from NQoT and from the mixture in QoLMW-T solution, was 0.806 g/l and 122.5 g/l, respectively.

The results obtained for the Gram positive, L. innocua and S. aureus bacteria yielded theoretical MIC from the 0.819 g/l NQoT, whereas that for the mixed solution was 107.5 g/l for Listeria, and 128.5 g/l for Staphylococcus. The experimental MICs for these M.O from the NQoT were 0.500 g/l, whereas those for the QLMW-T solution was 106.8 g/l.

MIC experimental calculations for both formulations show that the QoLMW prepared in a system with T boosts the bacterial inhibition effect, either in the solution or in the nanoparticulate dispersion, since the experimental MIC, (having variations depending on the tested bacterium), resulted in a 37.96% to 58.92% effect difference being lower than the values of the theoretical MIC for NQoT, whereas the effect difference between the theoretical MIC and the experimental MIC, of the mixture in the QoLMW-T solution, was lower, that is, from 1.39 to 39.92%.

These results show the synergy existing between oLMW and T in their AM activity. However, NQoT dispersion's required experimental concentrations ranged from about 1.5 to about 30 times lower than the experimental MIC as observed for the mixed solution, demonstrating that the NQoT dispersion presents a strong AM activity with respect to a mixture in solution of both active agents.

8.4 Effect of Glycerol on AM Activity of the NQoT Dispersion

Adding 20% v/v glycerol was required to modify the physicochemical properties of the NQoT dispersion, efficient incorporation of the NQoT into Qo and Qo/EPQ films by printing having been achieved. However, the particle size, PDI and potential Z were affected (see Table 1), reason by which it is important to evaluate the effect of glycerol on the NQoT's AM properties

The growth inhibition area was determined for the Gram negative, E. coli and Gram positive S. aureus bacteria with respect to NQoT dispersion and as compared with NQoT dispersion with 20% v/v glycerin. These results are shown in FIG. 5.

The growth inhibition area of the E. coli bacterium by NQoT dispersion was 9.4±0.4 mm², whereas it was 8.8±0, 3 mm² for the dispersion with 20% w/v glycerol, which shows that the addition of glycerol does not significantly affect the AM activity of the NQoT dispersion for this bacterium. In contrast, the growth inhibition area of S. aureus by NQoT dispersion was 6.8±0.4 mm², whereas it was 20% p/v glycerol dispersion was 5.3±0, 1 mm². These results showed that adding glycerol affects the AM activity of NQoT, depending on the kind of bacterium they are confronted with. This effect is attributed to the structural characteristics of each bacterium. S. aureus has a thick peptidoglycan wall that decreases the interaction with the bacterial cell membrane. The addition of NQoT glycerol would decrease the electrostatic interaction of the NQoT with the bacterial wall, since the effective adhesion of the active agent to the bacterial surface is required to achieve the biocidal effect (Kim et al., 2013), whereas E. coli is provided with an external membrane (EM) that is mainly composed of lipopolysaccharides, lipoproteins and phospholipids (Koebnik et al., 2000) and as was described in section 8.1 This kind of bacteria shows greater susceptibility to the active agents tested. Additionally, integral β-barrel proteins of the MO of Gram negative bacteria, generically referred to as porins, allow the passing of different solutes having different molecular weights, whether they are either antibacterial nutrients or toxins, which increases susceptibility of E. coli to the NQoT, with and without glycerol.

8.5 Anticrobial Activity of NQoT-Printed Qo and QO/EPQ Films.

The bacterial growth inhibition zone (GIZ) produced by the NQoT-printed films was determined after 3 and 24 hours of incubation with respect to the bacteria studied and was compared against the inhibition generated by the control films (without printed NQoT) and by films printed with Nps of Qo without T (NQo).

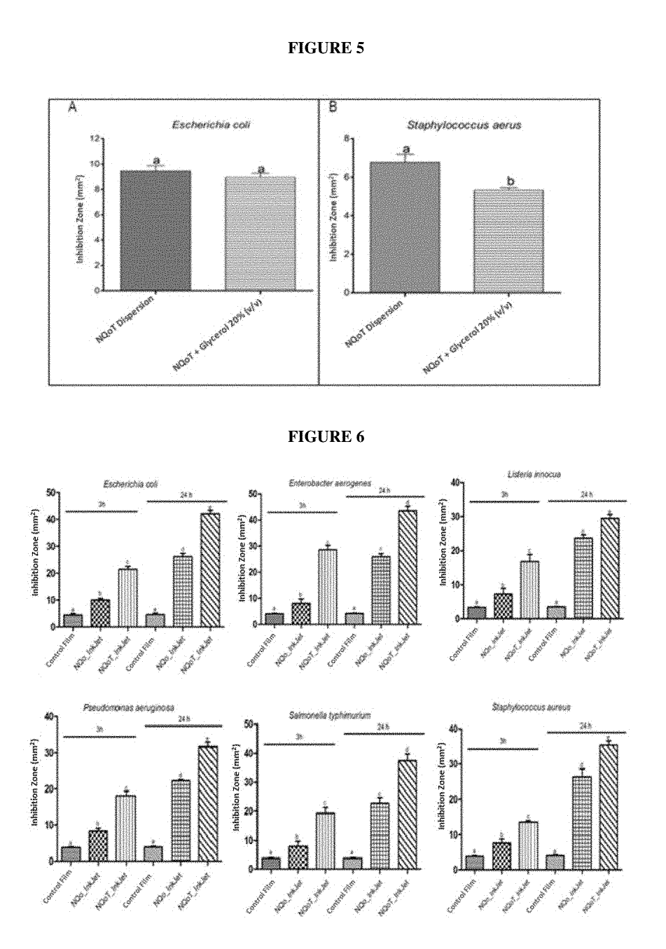

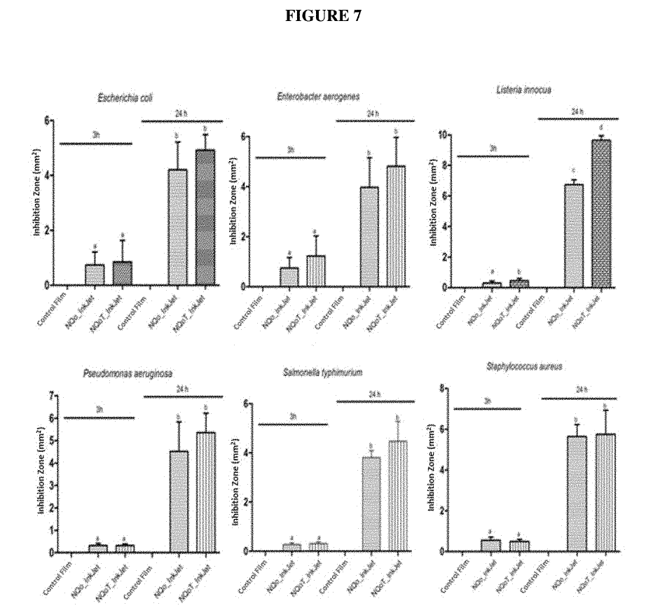

The results obtained for Qo and Qo/EPQ films are shown in FIG. 6 and FIG. 7, respectively.

As for the results in the GIZ generated by the Qo control film in E. coli (4.4±0.6 mm² and 4.6±0.6 mm²), E. aerogenes (4.0±0.2 mm²) and 4.1±0.2 mm²), P. aeruginosa (3.4±0.1 mm² and 3.5±0.1 mm²) and S. typhimurium (3.9±0.2 mm², and 3.9±0.2 mm²), no significant differences were found between 3 hours and 24 hours following incubation. Similar GIZ values were found for the bacteria Gram positive L. innocua (3.4±0.1 mm² and 3.5±0.1 mm²), and S. aureus (3.8±0.2 mm² and 4.0±0.4 mm²).

These values indicated that the Qo control films show moderate AM activity as of 3 hours against both kinds of bacteria (approximately 4.0 mm² on average). However, this was limited, since its effectiveness did not increase with a longer incubation period (24 hours), keeping the GIZ values relatively constant. These results are explained in accordance with what was described by Dutta et al., 2009, who established that Qo's AM activity depends on the application state, being more effective in the form of a solution than that of a film.

The inhibition caused by NQo-printed films in E. coli was 10.1±0.5 mm² and 26.2±1.2 mm², E. aerogenes 8.1±1.7 mm² and 25.9±1.2 mm², P. aeruginosa 8.3±0.8 mm², and 22.3±0.3 mm² and S. typhimurium 7.9±1.5 mm² and 22.7±2.1 mm², after 3 hours and 24 hours of incubation, respectively. A significant increase of between 2.5 times and 3.0 times, approximately, was observed in the inhibition of these Gram negative bacteria after 24 hours as compared to 3 hours of incubation. A similar inhibitory effect was found by these films on Gram positive bacteria where the GIZs were 7.2±1.6 mm² and 23.6±1.0 mm² for L. innocua, and 7.7±1.2 mm² and 25.4±2.2 mm² for S. aureus, where It was observed that the film's AM activity increases based on the time of exposure in the bacterial inocula.

The printing of NQo on the Qo film significantly increases the AM activity as shown by the control film in both incubation times. The higher AM activity observed by the NQo-printed films versus the control films, may be explained due from the swelling observed in the Qo film upon contact with the surface of the inoculated agar (data not shown), the film's uptaking water molecules from the in a heater (37° C.±1.0) is exacerbated as incubation time increases, which would allow the desorption of the NQos superficially arranged on the outer faces of the film, which could radially spread over the agar, increasing the contact surface with the tested bacteria, concomitant of the biocidal effect thereof.

The GIZ generated by the printed Qo films with printed NQoT were 21.4±1.1 mm² and 42.1±1.3 mm² for E. coli; 28.6±1.7 mm² and 43.6±1.8 mm² for E. aerogenes; 18.1±1.2 mm² and 31.6±1.2 mm² for P. aeruginosa; and 19.3±1.7 mm² and 37.5±2.4 mm² for S. typhimurium, after 3 and 24 hours of incubation, respectively.

These results showed AM's strong effect of these films, significantly exceeding the control films in the GIZ values in the amount approximately between 4.5 to 5.5 times, approximately, higher over 3 hours of incubation. These values rose to approximately 10 to approximately 12 times after 24 hours of incubation.

When comparing with the NQo-printed film, the NQoT-printed films surpass the GIZ values in these bacteria by approximately 2.5 to approximately 3.5 times over a 3-hour test. This tendency remained after the 24 hours. A similar tendency was shown by the GIZ generated in Gram positive L. innocua (16.81±0.1 mm² and 28.6±1.3 mm²) and S. aureus (13.6±0.5 mm² and 35.4±1.2 mm²) bacteria.

The strong AM effect, as associated with NQoT-printed films may be justified by several factors. On the one hand, as described in section 8.3, there is a synergistic effect between the QoLMW-T combination, which increases when generating nanoparticles with these solutions. In addition to NQoT desorption from the Qo matrix due to the uptake of water molecules and their consequent swelling during the incubation periods, and the release of T from the printed Nps. Within this context, T's release from NQo, which begins 2 hours after the test in an aqueous medium has been started and is runs for 48 hours. It has been reported that the release of active agents from NQo may be from the surface of the NQo, diffusion thereof taking place through the matrix by Qo's swelling or surface erosion.

FIG. 7 shows the results from the GIZ generated by the control NQo-printed or NQoT-printed Qo/EPQ films.

Control films lack AM activity, did not show any inhibition zone in any bacterial genus tested in either of the 2 incubation periods (3 and 24 hours). This is attributed to the effect of the presence of quinoa proteins in the mixture, and as was discussed in section 8.1, the mixture in solution between Qo/EPQ decreases, up to 100%, Qo's AM activity, all this in addition to the decline of the Qo's intrinsic AM activity when it is found as a film. However, when this kind of films printed NQo film was tested with printed NQo's, GIZs were generated in the Gram negative bacteria E. coli (0.8±0.4 mm² and 4.1±1.0 mm²), E. aerogenes (0, 7±0.4 mm², and 4.0±1.2 mm²), P. aeruginosa (0.3±0.1 mm² and 4.5±1.2 mm²) and S. typhimurium (0.3±0.1 mm² and 3.7±0.3 mm²), after 3 and 24 hours of incubation, respectively.

As for L. innocua and S. aureus bacteria, GIZ of 0.3±0.1 mm² and 0.5±0.2 mm², respectively, were observed after 3 hours of incubation, and 6.7±0.2 mm² and 5.6±0.6 mm², respectively, after 25 hours of incubation.

These results show the same tendency as observed NQo-printed Qo films, where the GIZs increased proportionally with a longer incubation period.

As regards NQoT-printed Qo/EPQ films, the inhibitions generated were 0.9±0.7 mm² and 4.9±0.6 mm² for E. coli; 1.2±0.7 mm² and 4.8±1.1 mm² for E. aerogenes; 0.3±0.1 mm² and 5.4±0.9 mm² for P. aeruginosa; and 0.3±0.1 mm² and 4.5±0.1 mm² for S. typhimurium, after 3 and 24 hours of incubation, respectively.

The Gram positive bacteria generated a GIZ as compared to those 0.4±0.2 mm² and 9.6±0.3 mm² films for L. innocua, and of 0.4±0.1 mm² and 5.7±1.2 mm² for S. aureus, during each incubation time.

It was found that the inhibitory activity rises depending on the incubation time relating to both kinds of MO.

When comparing the GIZ as generated by the NQoT-printed films to the NQo-printed films after 3 and 24 hours of incubation, no significant differences were found either in Gram-negative or Gram-positive bacteria.

8.6 Activity of NQoT-Printed Qo and QO/EPQ Films Versus Botrytis cinérea

The NQoT/printed Qo and Qo/EPQ films were compared to a culture containing B. cinerea spores where the capacity of these films to mitigate germination for 5 days was assessed. The results were compared to control films (without printed NQoT) and to both kinds of NQo-printed films. IN addition, a germination control was assessed as a viability parameter.

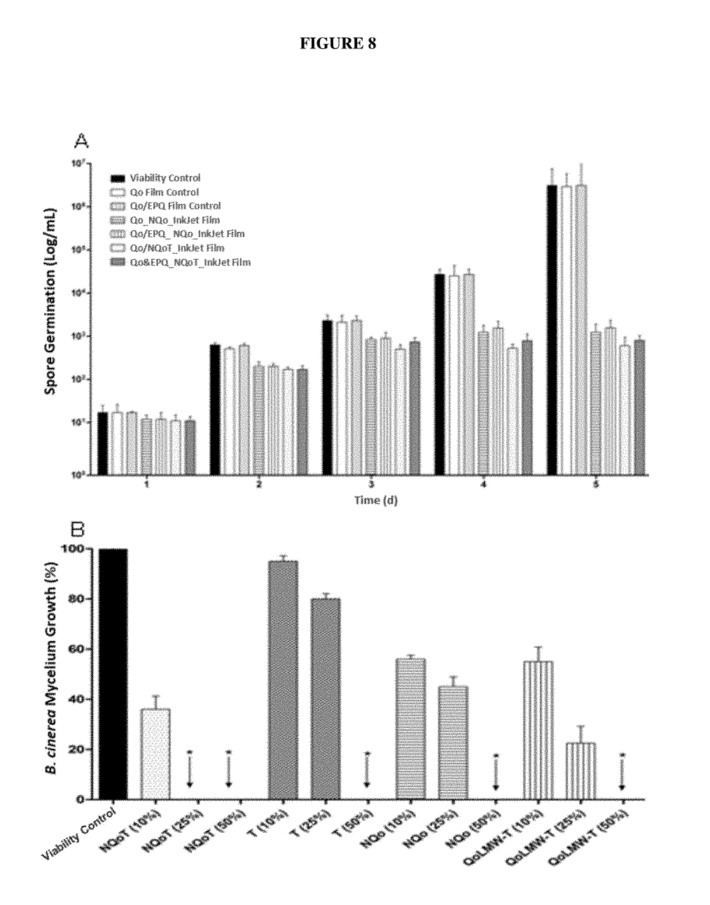

The results are contained in FIG. 8A, which shows that the culture of spores without the presence of films, germinates exponentially showing conditions suitable for the germination process, for which the test lacks artifacts.

After 24 hours of incubation, each culture (with the respective type of films) germinated without yielding significant differences between the cultures containing the control films, NQo-printed films and NQoT-printed films, all of them proliferated at the same level as the viability control (approximately 1.2 logarithmic cycles).

After 2 days of testing, both types of NQoT- and NQo-printed films, respectively, showed a similar degree of spore germination reduction with respect to the control film, both types of films as printed with both types of Nps were able to reduce approximately 30% the germination of Botrytis spores, whereas the control film did not show any germination reduction as compared to the viability control, which allowed the increase of approximately 2.1 log from test start. A phenomenon similar to the one above was observed on the third test day, where the control films showed no significant effect relating to the spore growth, while the Qo and Qo/EPQ films, as printed with both kinds of Nps, kept the approximately 30% germination inhibition effect as compared to both types of control films and viability culture.

No differences relating to the reduction of germination observed based on the kind of Qo or Qo/EPQ matrix and the kind of Nps printed thereon.

After 4 days into the test start, the NQoT-printed Qo film shows a germination reduction of 2.3±0.1 logarithmic cycles of spores as compared to the viability control and both control films, which caused the increase of approximately 2.5×10⁴ spores/ml. It was also found that there was no increase in spore germination as compared to day 3 days of the culture with this kind of film. A similar phenomenon was observed with the hybrid NQoT-printed film, which controlled, in the same way, the proliferation of spores in the culture.

NQoT printing on both types of films was about 2.5 times more inhibition effective than with NQo-printed films.

Upon test period end (5th day), it was observed that the Qo and Qo/EPQ films as printed with both kinds of Nps significantly inhibit spore germination in 4 logarithmic cycles, (without showing any differences between the kind of film and kind of printed Nps), with respect to control films and viability control.

Interestingly, this test made it possible to establish that the NQoT and the NQo, as incorporated by thermal injection in both kinds of film, in addition to allowing to control spore germination of B. cinerea, with respect to non-printed films, were able to show a strong sporistatic effect, because spore germination did not show any increase from test day 3 to test day 5, keeping a 2.5×10³ spore/ml average when the printed films were present in the culture.

On the other hand, the antifungal capacity of the NQoTs confronted to the vegetative form of Botrytis cinerea was tested, wherein the growth inhibition of this fungus' mycelium was assessed, adding diluted concentrations to the culture medium of the NQoT dispersion. The dilutions tested corresponded to 10%, 25% and 50% v/v, and were compared to T's solutions, QoLMW-T mixture, and NQo dispersion in the same dilutions. The results obtained are shown in FIG. 8B.

It was observed, when the culture medium lacked the solutions or dispersions to be tested (viability control), that the fungus spread over the surface of the plate (8.5 cm²), equivalent to 100% growth, which was used as a growth comparison parameter.

It was found, when analyzing the effect of the active agents at their highest dilution (10% v/v), that NQoT dispersion causes the radial growth of B. cinerea mycelium to rise to 3.1±0.2 cm², which was equivalent to 63.5% inhibition as compared to the viability control. In turn, when the T solution was present in the culture medium, the fungus showed a plaque growth of 8.1±0.1 cm², 4.7% lower than the viability control. The NQos inhibited the growth of micellar propagation by 44% (4.7±0.3 cm²), while the QoLMW-T mixture solution inhibited at the same level as the NQos, reaching identical inhibition percentage. These results showed NQoTs' effectiveness, even at 90% diluted from the stock solution used on this work, since its effectiveness in inhibiting the vegetative form of B. cinerea was 13.5 times greater than the inhibitory effect shown by the T solution, and 1.4 times higher than NQo dispersion and QoLMW-T mixture solution.

When the active agents were tested in 25% v/v dilutions, the NQoT dispersion was able to inhibit, by 100%, the proliferation of the fungus after the test time (6 days), whereas when T was present in the culture medium, a 6.8±0.8 cm² radial mycelial growth (20% inhibition) was observed. The NQos in this dilution allowed the growth of Botrytis over a 3.8±0.7 cm² area of the plate, achieving 55.2% inhibition with respect to the viability control.

The QoLMW-T mixture solution allowed for the propagation of the fungus by 1.9±0.4 cm² of the plate, which was equivalent to 77.6%. This result allowed to establish that a 1.1 mg/ml concentration (diluted at 25%) is sufficiently effective to generate a fungicidal effect against B. cinerea fungus.

These results showed the synergic effect between QoLMW and T, which is increased in the case of nanoparticulate solutions, being in line with what was shown in the bacteriological tests.

Finally, all the 50% diluted solutions and dispersions inhibit, by 100%, the growth of the mycellium of the filamentous fungus

These findings show that the use of printable nanotechnology may improve the functionality of films made from renewable biopolymers, which may add to the development of new packaging materials having application in the food industry, aimed at extending the shelf life of low pH fresh fruit and allowing for consumers' food safety.

The biopackage is made from edible bioactive films that is made up of high molecular weight chitosan or a mixture of high molecular weight chitosan and an aqueous quinoa protein extract. Later, one of the package's faces is print coated with a mixture of a printable chitosan nanoparticle suspension and glycerol-dispersed chitosan thymol.

The process comprises obtaining the edible bioactive film as a sheet of paper, which comprises a high molecular weight chitosan solution or mixing the high molecular weight chitosan solution with the aqueous quinoa protein extract at pH 11, adjusting pH at 3.5, dry at 50° C. until reaching a constant weight. Concurrently, a chitosan nanoparticle-based suspension (low viscosity), and chitosan thymol nanoparticle-based suspension dispersed in glycerol is prepared to obtain a “printing ink”. Finally, by means of a thermal inkjet (TU) system, one side of the paper sheet of the aforementioned film is printed with said suspension.

The abovementioned process is described, in detail, as follows:

1.—The material of the matrix (or base) making up this package is comprised of high molecular weight chitosan, or a mixture of high molecular weight chitosan and an aqueous quinoa protein extract, extracted at pH 11, a material such as paper sheet being obtained.

2.—Simultaneously, chitosan nanoparticles (of low molecular weight) and thymol with sodium tripolyphosphate dispersed in glycerol are prepared. These nanoparticles are the main ingredient of what constitutes a “printing ink”, and is, in turn, separately made from the film mentioned in point 1. Once obtained this printable chitosan nanoparticle suspension and chitosan thymol suspension dispersed in glycerol, stage 3 is started.

3.—A Hewlett-Packard, model 4000k210, printer (Hewlett-Packard Inc.) is used, which uses “drop-on-demand” (DOD) technology, using a thermal inkjet system (TIJ). As for the printing process, only modified black-ink cartridges (HP 675, cn690A) were used, the upper section being cut, and the cartridges were loaded with 20 ml of each ink dispersion of the nanoparticles obtained in stage 2.

4.—For printing with the nanoparticulate antimicrobial ink obtained in stage 2 on the Qo and Qo/EPQ films (as obtained in stage 1), a 8.8×8.8 cm square of these films was used, on which the nanoparticles prepared in step 2 were printed and loaded into the print cartridges.

The method for forming bio-packages comprises folding the above described edible biodegradable films, leaving the printable face with nanoparticles in an inward position, sealing said films and forming a bag.

### REFERENCES

Abdollahi, M., Rezaei, M., Farzi, G. (2012). A novel active bionanocomposite film incorporating rosemary essential oil and nanoclay into chitosan. Journal of Food Engineering, 111, 343-350.
Abugoch, L. (2009). Quinoa (Chenopodium quinoa Willd.): Composition, Chemistry, Nutritional, and Functional Properties. In Advances in Food and Nutrition, 58, 1-32. Elsevier INC.
Abugoch, L., Romero, N., Tapia, C., Rivera, M., y Silva, J. (2008). Study of some physicochemical and functional properties of quinoa (Chenopodium quinoa Willd.) protein isolates. Journal of Agricultural and Food Chemistry, 56(12), 4745-4750.
Abugoch, L., Tapia, C., Villamán, M., Yazdani-Pedraman, M., Díaz-Dosque, M. (2011). Characterization of quinoa protein chitosan blend edible films, Food Hydrocolloids, 25, 879-886.
Adame, D., y Beall, G. W. (2009). Direct measurement of the constrained polymer region in polyamide/clay nanocomposites and the implications for gas diffusion. Applied Clay Science, 42, 545-552.
Agnihotri, S., A., Mallikarjuna, N., N., y Aminabhavi, T., M. (2004). Recent advances on chitosan based micro- and nanoparticles in drug delivery, J. Control. Release, 100, 5-28.
Akbari, B., Pirhadi, M., y Zandrahim M. (2011). Particle size characterization of nanoparticles: A practical approach. Iranian Journal Of Material Science and Engineering, 8(2), 48-56.
Ali, S. W., Rajendran, S., y Joshi, M. (2011). Synthesis and characterization of chitosan and silver loaded chitosan nanoparticles for bioactive polyester. Carbohydrate Polymers, 83, 438-446.
Almenar, E., Samsudin, H., Auras, R., Harte, B., y Rubino, M. (2008). Postharvest shelf life extension of blueberries using a biodegradable package. Food Chemistry, 110, 120-127.
Ando, H., Chen, Y., Tang, H., Shimizu, M., Watanabe, K. y Miysunaga, T. (2002). Food Components in Fractions of Quinoa Seed. Food Science and Technology Research 8(1), 80-84.
Andreuccetti, C., Carvalho, R. y Grosso, C. (2010). Gelatin-based films containing hydrophobic plasticizers and saponin from Yucca schidigera as the surfactant. Food Research International, 43, 1710-1718.
Appendini, P., y Hotchkiss, J. (2001). Surface modification of poly(styrene). by the attachment of an antimicrobial peptide. Journal of Applied Polymer Science, 81, 609-616.
Asociación Nacional de fruta fresca, (2011). Industria Frutícola Chilena. Fecha de acceso de 16 de Diciembre de 2011.
Ayranci, E., y Tunc, S. (1997). Cellulose-based edible films and their effects on fresh beans and strawberries. Zeitschrift fur Lebensmittel Untersuchung and Forschung A, 205, 470-473.
Avena-Bustillos, R., y Krochta, J. (1993). Water vapor permeability of caseinate-based edible films as affected by pH, calcium crosslinking and lipid content. Journal of Food Science, 58, 904-907.
Babic, I., Watada, A., E., (1996). Microbial populations of fresh-cut spinach leaves affected by controlled atmospheres. Postharvest Biol. Technol, 9, 187-193.
Badawy, M., y Rabea, E. (2009). Potential of the biopolymer chitosan with different molecular weights to control postharvest gray mold of tomato fruit. Postharvest Biology and Technology, 51, 110-117.
Baldwin, E. (1994). Edible films and films to improve food quality. In J. Krochta E. Baldwin y M. Nisperos-Carriedo (eds), Edible Films for Fresh Fruits and Vegetables: past, present and future. pp 24-64. Technomic Publishing Co., Inc, Lancaster, U.S.A.
Baldwin, E., Nisperos, M., Hagenmaier, R. y Baker, R. (1997). Use of lipids in films for food products. Food Technology, 51(6), 6-63.
Banerjee, R. y Chen, H. (1995). Functional properties of edible films using whey protein concentrate. Journal of Dairy Science, 78, 1673-1683.
Banerjee, T., Singh, A., Sharma, R., Maitra, A. (2005). Labeling efficiency and biodistribution of technetiumlabeled nanoparticles: interference by colloidal tin oxide particles. Int. J. Pharm, 289, 189-195.
Bauer, A. W., Kirby, W. M., Sherris J. C. y Turck, M. (1966). Antibiotic susceptibility testing by a standardized single disk method. Am. J. Clin. Pathol, 45, 493-496.
Begin, A., Van Calsteren, M. (1999). Antimicrobial films produced from chitosan. Int J Biol Macromol. 26(1), 63-67.
Beirão da Costa, S., Duarte, C., Bourbon, A., Serra, T., Moldão Martins, M., Duarte, C., Beirão da Costa, M. (2011). Effect of the matrix system in the delivery and in vitro bioactivity of microencapsulated Oregano essential oil. Journal of Food Engineering. doi: 10.1016/j.jfoodeng.2011.05.043.
Berger, J., Reist, M., Mayer, J., Felt, O., Peppas, N., Gurny, R. (2004). Structure and interactions in covalently and ionically crosslinked chitosan hydrogels for biomedical applications. Eur J Pharm Biopharm. 57(1): 19-34.
Beuchat, L., R. (2002). Ecological factors influencing survival and growth of human pathogens on raw fruits and vegetables. Microbes Infect 4:413-23.
Bharadwaj, R. K. (2001). Modeling the barrier properties of polymer-layered silicate nanocomposites. Macromolecules, 34, 9189-9192.
Bonilla, J., Atarés, L., Vargas, M. y Chiralt, A. (2012). Effect of essential oils and homogenization conditions on properties of chitosan-based films. Food Hydrocolloids 26, 9-16.
Bourtoom, T. (2008). Review Article: Edible films and films: characteristics and properties. International Food Research Journal 15(3): 237-248.
Bouten, P., Zonjee, M., Bender, J., Yauw, S., van Goor, H., van Hest, J., y Hoogenboom, R. (2014). The chemistry of tissue adhesive materials. Progress in Polymer Science, 39(7), 1375-1405.
Braga, P., Culici, M., Alfieri, M., Dal Sasso, M. (2008). Thymol inhibits Candida albicans biofilm formation and mature biofilm. International Journal of Antimicrobial Agents 31:472-477.
Brandi, M. T. (2006). Fitness of human enteric pathogens on plants and implications for food safety. Annual Review of Phytopathology 44, 367-392.
Brandsch, J., Mercea, P., Tosa, V., Piringer, O. (2002). Migration modeling as a tool for quality assurance of food packaging. Food Addit. Contam., 19, 22-41.
Brinegar, C. y Goundan, S. (1993). Isolation and characterization of chenopodin, the 11S seed storage protein of quinoa (Chenopodium quinoa). Journal of Agricultural and Food Chemistry 41, 182-185.
Brinegar, C., Sine, B. y Nwokocha, L. (1996). High-cysteine 2S seed storage proteins from Quinoa (Chenopodium quinoa). Journal of Agricultural and Food Chemistry 44(7), 1621-1623.
Brotz, H., Bierbaum, G., Markus, A., Molitor, E., Sahl, H. G. (1995). Mode of action of the lantibiotic mersacidin-inhibition of peptidoglycan biosynthesis via a novel mechanism. Antimicrobial Agents and Chemotherapy. 39(3):714-719.
Buanz, A., Saunders, M., Basit, A y Gaisford, S. (2011). Preparation of Personalizeddose Salbutamol Sulphate Oral Films with Thermal Ink-Jet Printing. Pharm Res. 28:2386-2392.
Buonocore, G. G., Conte, A., Corbo, M. R., Sinigaglia, M. y Del Nobile, M. A. (2005). Mono- and multilayer active films containing lysozyme as antimicrobial agent. Innovative Food Science and Emerging Technologies, 6, 459-464.
Butler, B., Vergano, P., Testin, R., Bunn, J. y Wiles, J. (1996). Mechanical and barrier properties of edible chitosan films as affected by composition and storage. Journal of Food Science 61(5), 953-955.
Callegarin, F., Quezada, J., Debeaufort, F. y Voilley, A. (1997). Lipids and Biopackaging. Journal of the American Oil Chemist Society, 74, 1183-1192.
Calderon, I., L., Caro, N., J., Morales, E., A., Collao, B., Gil, F., Villarreal, J., M., Ipinza, F., y Saavedra C., P. (2011). The response regulator ArcA of Salmonella enterica serovar Typhimurium down-regulates the expression of OmpD, a porin that facilitates the uptake of hydrogen peroxide. Res Microbiol. 162(2). 214-222.
Calvo, C. Remuñán-López, J. L. Vila-Jato, M. J Alonso. (1997). Novel hydrophilic chitosan-polyethylene oxide nanoparticles as protein carriers. Journal of Applied Polymer Science. 63: 125-132.
Caner, C., Vergano, P. y Wiles, J. (1998). Chitosan films: mechanical and permeation properties as affected by acid, plasticizer, and storage. Journal of Food Science 63(6), 1049-1053.
Cao, Y. y Chang, K. (2001). Edible films prepared from water extract of soybeans. Journal of Food Science 67(4), 1449-1454.
Casariego, A., Souza, B., Cerqueira, M., Teixeira, J., Cruz, L., Díaz, R, (2009). Chitosan/clay films' properties as affected by biopolymer and clay micro/nanoparticles' concentrations. Food Hydrocolloids, 23, 1895-1902.
Cheftel, J., Cuq, J. y Lorient, D. (1985) Amino acids, peptides, and proteins In O. Fennema (ed), Food Chemistry. pp 245-369. Marcel Dekker, New York.
Chenite, A., Chaput, C., Wang, D., Combes, C., Buschmann, M., Hoemann, C., Leroux, J., Atkinson, B., Binette, F., Selmani, A. (2000). Novel injectable neutral solutions of chitosan form biodegradable gels in situ. Biomaterials. 21(21):2155-216.
Cheng, M., Deng, J., Yang, F., Gong, Y., Zhao, N. y Zhang, X. (2003). Study on physical properties and nerve cell affinity of composite films from chitosan and gelatin solutions. Biomaterials 24, 2871-2880.
Cheng, C., Fang-Yu, W., Ching-Feng, M., Wei-Tung, L. y Ching-Dong, H. (2008). Studies of chitosan: II. Preparation and characterization of chitosan/poly(vinyl alcohol)/gelatin ternary blend films. Journal of Biological Macromolecules 43, 37-42.
Chiumarelli, M., y Hubinger, M, (2014). Evaluation of edible films and films formulated with cassava starch, glycerol, carnauba wax and stearic acid. Food Hydrocolloids, 38, 20-27.
Choa, S. Y., y Rhee, C. (2004). Mechanical properties and water vapor permeability of edible films made from fractionated soy proteins with ultrafiltration. Lebensm.-Wiss. u.-Technol, 37, 833-839.
Chu, C., L., Liu, W., T., Zhou, T., y Tsao, R. (1999). Control of postharvest gray mold rot of modified atmosphere packaged sweet cherries by fumigation with thymol and acetic acid. Canadian Journal of Plant Science, 685-689.
Clapper, J. D., Pearce, M. E., Guymon, C. A., y Salem, A. K. (2008). Biotinylated biodegradable nanotemplated hydrogel networks for cell interactive applications. Biomacromolecules, 9(4), 1188-1194.
Clapper, J., D., Iverson, S., L., Guymon, C., A. (2007). Biomacromolecules 8, 2104-2111.
Colla, E., Sobral, P. y Menegalli, F. (2006) Amaranthus cruentus flour edible films: influence of stearic acid addition, plasticizer concentration, and emulsion stirring speed on water vapor permeability and mechanical properties. Journal of Agricultural and Food Chemistry 54, 6645-6653.
Cortez, M., Martínez, A., Ezquerra, J., Graciano, A., Rodriguez, F., Castillo, M, (2010). Chitosan composite films: Thermal, structural, mechanical and antifungal properties. Carbohydrate Polymers, 82, 305-315.
Cota, L., L. Maffia, E. Mizubuti, P. Macedo, y R. Antunes. (2008). Biological control of strawberry gray mold by Clonostachys rosea under field conditions. Biological Control 46:515-522.
Cotter, P. D., Hill, C., Ross, R. P. (2005). Bacteriocins: Developing innate immunity for food. Nature Reviews of Microbiology. 3:777-788.
Cran, M., Rupika, L., Sonneveld, K., Miltz, J., Bigger, S. (2010). Release of Naturally Derived Antimicrobial Agents from LDPE Films Journal of Food Science. 75(2), 126-133.
Cunningham, P., Ogale, A., Dawson, P., y Acton, J. (2000). Tensile Properties of Soy Protein Isolate Films Produced by a Thermal Compaction Technique. Journal of Food Science, 65 (4), 668-671.
Davis, T., Yezek, L., Pinheiro, J., y van Leeuwen, H. (2005). Measurement of Donnan potentials in gels by in situ microelectrode voltammetry. Journal of Electroanalytical Chemistry, 584(2). 100-109.
De Gans B-J, Duineveld P C, Schubert U S. (2004). Inkjet printing of polymers: State of the art and future developments. Adv Mater 16:203-213.
De Moura, M., Aouada, F., Avena-Bustillos, R., McHugh, T., Krochta, J., y Mattoso, L. (2009). Improved barrier and mechanical properties of novel hydroxypropyl methylcellulose edible films with chitosan/tripolyphosphate nanoparticles. Journal of Food Engineering, 92, 448-453.
Debeaufort, F. y Voilley, A. (1995). Effect of surfactants and drying rate on barrier properties of emulsified edible films. International Journal of Food Science y Technology 30, 183-190.
Debeaufort, F., Quezada-Gallo, J. y Voilley, A. (1998). Edible films and films: tomorrow's packings: A review. Critical Reviews in Food Science and Nutrition 38(4), 299-313.
Defilippi, B. (24 de marzo de 2009). Postcosecha de Frutas y Hortalizas. Punta Arenas, Chile: INIA; Nodo Hortofrutícola.
Del Campo J., Amiot, M. J., Nguyen—The C. (2000). Antimicrobial effect of Rosemary extracts. Journal of Food Protection. 10: 1359-1368.
Del Nobile, M. A., Conte, A., Incoronato, A. L., y Panza, O. (2008).
Antimicrobial efficacy and release kinetics of thymol from zein films. Journal of Food Engineering, 89, 57-63.
Denavi, G., Pérez-Mateos, M., Añón, M., Montero, P., Mauri, A. y Gómez-Guillen, C. (2009). Structural and functional properties of soy protein isolate and cod gelatin blend films. Food Hydrocolloids, 23, 2094-2101.
Devlieghere, F., Vermeulen, A., y Debevere, J. (2004). Chitosan: antimicrobial activity, interactions with food components and applicability as a film on fruit and vegetables. Food Microbiology, 21, 703-714.
Di Pierro, P., Chico, B., Villalonga, R., Mariniello, L., Damiao, A. y Masi, P. (2006). Chitosan-whey protein edible films produced in the presence of transglutaminase: analysis of their and barrier properties. Biomacromolecules. 7, 744-749.
DIRECOM (2011). Comercio Exterior de Chile Cuarto Trimestre 2010. Fecha de acceso 27 de diciembre de 2011. http://www.sice.oas.org/ctyindex/CHL/DIRECON20104_s.pdf.
Dong, A., Huang, P. y Caughey, W. (1990). Protein secondary structures in water from second-derivative amide I infrared spectra. Biochemistry, 29, 3303-3308.
Droby, S., y Lichter, A., (2004). Post-harvest Botrytis infection: etiology, development and management. In: Elad, Y., Williamson, B., Tudzynski, P., Delen, N. (Eds.), Botrytis: Biology, Pathology and Control. Kluwer Academic Publishers, London, UK, 349-367.
Du, W-L., Niu, S-S., Xu, Y-L., Xu., Z-R., Fan, C-L. (2009). Antibacterial activity of chitosan tripolyphosphate nanoparticles loaded with various metal ions. Carbohydrate Polymers 75: 385-389.
Durango, A., Soares, N., y Andrade, N. (2006). Microbiological evaluation of an edible antimicrobial film on minimally processed carrots. Food Control, 17, 336-341.
Dukhin, S., Zimmermann, R., Duval, J., y Werner, C. (2010). On the applicability of the Brinkman equation in soft surface electrokinetics. Journal of Colloid and Interface Science, 350, 1-4.
Dutta, P., Tripathi, S., Mehrotra, G., y Dutta, J. (2009). Perspectives for chitosan based antimicrobial films in food applications. Food Chemistry 114: 1173-1182.
El Ghaouth, A. (1992). Antifungal activity of chitosan on two postharvest pathogens of strawberry fruits. Phytopathology, 82, 398-402.
Elad, Y., B. Williamson, P. Tudzynski, y N. Delen. (2004). Botrytis: Biology, pathology and control. 403 p. Kluwer Academic Press, Dordrecht, The Netherlands.
European Food Safety Authority. (2009). The Potential Risks Arising from Nanoscience and Nanotechnologies on Food and Feed Safety. The EFSA Journal. 958, 1-39
Fan, W., Yan, W., Xu, Z., y Ni, H. (2011). Formation mechanism of monodisperse, low molecular weight chitosan nanoparticles by ionic gelation technique. Colloids and surfaces B: Biointerfaces. doi:10.1016/j.colsurfb.2011.09.04
Fernández-López, J., Zhi, N., Aleson-Carbonell, L., Pérez-Álvarez, J. A., Kuri, V. (2004). Antioxidant and antibacterial activities of natural extracts: application in beef meatballs. Meat Science. 69: 371-380.
Franz, E., y van Bruggen, A. H. (2008). Ecology of E. coli O157:H7 and Salmonella enterica in the primary vegetable production chain. Critical Reviews in Microbiology 34, 143-161.
Freudenberg, U., Zimmermann, R., Schmidt, K., Holger Behrens, S., y Werner, C. (2007). Charging and swelling of cellulose films. Journal of Colloid and Interface Science 309: 360-365.
Galván Márquez, I., Akuaku, J., Cruz, I., Cheetham, J., Golshani, A., Smith, M. (2013). Disruption of protein synthesis as antifungal mode of action by chitosan. International Journal of Food Microbiology 164: 108-112.
Galvéz, A., Aravena, E. y Mondaca, R. (2006). Isotermas de Adsorcion en Harina de Maíz. Ciencia y Tecnologiá de Alimentos, Campinas, 26(4):821-827.
Galietta, G., Di Gioia, L., Guilbert, G. y Cuq, B. (1998). Mechanical and thermomechanical properties of films based on whey proteins as affected by plasticizer and crosslinking agents. Journal of Dairy Science 81, 3123-3130.
Gamboa. (2010). Report on Research Stay (The University of Texas at Austin): manufacture of chitosan with and triclosan by using SFL technique. Texas, USA.
Garsuch, V., y Breitkreutz, J., (2010). Comparative investigations on different polymers for the preparation of fast-dissolving oral films. J Pharm Pharmacol., 62:539-45.
Ge, Y., Zhang, Y., He, S., Nie, F., Teng, G., y Gu, N. (2009). Fluorescence Modified Chitosan-Coated Magnetic Nanoparticles for High-Efficient Cellular Imaging. Nanoscale Res Lett, 4, 287-295.
Genina, N., Janben, M., Breitenbach, A., Breitkreutz, J., y Sandler, N. (2013). Evaluation of different substrates for inkjet printing of rasagiline mesylate. European Journal of Pharmaceutics and Biopharmaceutics, 85(3), 1075-1083.
Gennadios, A., McHugh, T., Weller, C. y Krochta, J. (1994). Edible films and film based on proteins In J. Krochta E. Baldwin and M. Nisperos-Carriedo (eds), Edible Films and Films to Improve Food Quality. pp 201-277. Technomic Publishing Co., Inc., Lancaster, Pa.
Gennadios, A. y Weller, C. (1990). Edible films and films from wheat and corn proteins. Food Technology, 44(10), 63-69.
Gennadios, A., Weller, C., Hanna, M. y Froning, G. (1996). Mechanical and barrier properties of egg albumen films. Journal of Food Science, 61, 585-589.
Ghanem A., Skonberg, D., (2002). Effect of Preparation Method on the Capture and Release of Biologically Active Molecules in chitosan Gel Beads. Journal of Applied Polymer Science, 84, 405-413.
Gorinstein, S., Zemser, M., y Octavio, P.-L. (1996). Structural Stability of Globulins. Journal of Agriculture and Food Chemestry, 44, 100-105.
Goycolea Valencia F. M., Remuñan López C., Alonso M. J. (2009) Nanopartículas a base de polisacáridos: quitosano. En: (Vila Jato, J. L. ed.) Nanotecnología Farmacéutica: Realidades y posibilidades farmacoterapéuticas. Real Academia Nacional de Farmacia. Madrid, España. Pag. 103-113.
Grob, K. (2008). The future of simulants in compliance testing regarding the migration from food contact materials into food. Food Control, 19, 263-268.
Guarda, A., Rubilar, J., Miltz, J., Galotto, M. (2011). The antimicrobial activity of microencapsulated thymol and carvacol. International Journal of Food Microbiology, 146, 144-150.
Guerrero, P., Hanani, Z., Kerry, J. y De la Caba, K. (2011). Characterization of soy protein-based films prepared with acids and oils by compression. Journal of Food Engineering, 107, 41-49.
Guilbert, S. (1986). Technology and application of edible protective films. In M. Mathlouthi (ed), Food Packaging and Preservation. pp 371. Elsevier applied science publishers, London.
Hammer, K., Carson, C., y Riley, T. (1999). Antimicrobial activity of essential oils and other plant extracts. Journal of Applied Microbiology, 86, 985-990.
Heaton, J., y, Jones, K. (2008). Microbial contamination of fruit and vegetables and the behaviour of enteropathogens in the phyllosphere: a review. Journal of Applied Microbiology, 104, 613-626.
Henriette, M. C. (2009). Nanocomposites for food packaging applications. Food Research International, 42(9), 1240-1253.
Hernández-Lauzardo, A., Bautista-Baños, S., Velázquez-del Valle, M., Méndez-Montealvo, M., Sánchez-Rivera, M., Bello-Pérez, L. A. (2008). Antifungal effects of chitosan with different molecular weights on in vitro development of Rhizopus stolonifer (Ehrenb.:Fr.) Vuill. Carbohydrate Polymers, 73, 541-547.
Hewlett-Packard Inc. Pagewide technology. (2012) Development Company.
Hsu, B., Weng, Y., Liao, Y. y Chen, W. (2005). Structural investigation of edible zein films/films and directly determining their thickness by FT-Raman spectroscopy. Journal of Agricultural and Food Chemistry, 53, 5089-5095.
Hu, B., Pan, C., Sun, Y., Hou, Z., Hu, B., Zeng, X. (2008). Optimization of fabrication parameters to produce chitosan-tripolyphosphate nanoparticles for delivery of tea catechins. J Agric Food Chem, 27, 56(16):7451-8.
Hu, J., A. (2003). Nanoparticle engineering process: spray-freezing into liquid to enhance the dissolution of poorly water soluble drugs. Dissertation Presented to the Faculty of the Graduate School of The University of Texas at Austin in Partial Fulfillment of the Requirements for the Degree of Doctor of Philosophy. Texas, EEUU: The University of Texas at Austin (August de 2003).
Hung, H., C., Joshipura, K., J., Jiang, R., Hu, F., B., Hunter, D., Smith-Warne, S., A. (2004). Fruit and Vegetable Intake and Risk of Major Chronic Disease. Journal of the National Cancer Institute, 96 (21), 1577-1584.
Hung, L., H., Le, A., P. (2007). Microfluidic devices for the synthesis of nanoparticles and biomaterials. Journal of Medical and Biological Engineering, 27, 1-6.
Jancurová, M., Minaravicová, L., y Dandár, A. (2009). Quinoa—a Review. Czech Journal of Food Science, 27(2), 71-79.
Jang, K., I., y Lee, H., G. (2008). Stability of chitosan nanoparticles for L-ascorbic acid during heat treatment in aqueous solution. J Agric Food Chem, 56(6), 1936-41.
Jae-Woon, N. y Mi-Kyeong, J. (2002). Spectroscopic characterization and preparation of low molecular, water soluble chitosan with free amine group by novel methods. Journal of Polymer Science Part A: Polymer Chemestry, 40(21), 3796-3803.
Jenssen, H., Hamill, P., Hancock, E. W. R. (2004). Peptide antimicrobial agents. Clinical Microbiology Reviews, 19(3), 491-511.
Jeon, Y., Kamil, J. y Shahidi, F. (2002). Chitosan as an edible invisible film for quality preservation of herring and atlantic cod. Journal of Agricultural and Food Chemistry, 50, 5167-5178.
Johnston, K. A. y Duckworth, R. B. (1985). The influence of soluble components on water sorption hysteresis, in properties of water in foods, Ed by Simatos, D y Multon, J. L., Martinus Nijhoff, Dordrecht, pp 65-81.
Jones, J. D., y Dangl, J. L. (2006). The plant immune system. Nature 444: 323-329. Kabara, J., J. (1991) Phenols and chelators. In Food Preservatives, eds Russell, N. J. and Gould, G. W. pp. 200-214. London: Blackie.
Karyotis, T., Iliadis, C., Noulas, C. y Mitsibonas, T. (2003). Preliminary research on seed production and nutrient content for certain quinoa varieties in a saline-sodic. Journal of Agronomy and Crop Science, 189, 402-408.
Kean, T., Thanou M. (2010). Biodegradation, biodistribution and toxicity of chitosan. Advanced Drug Delivery Reviews, 62, 3-11.
Keawchaoon L., Yoksan, R. (2011). Preparation, characterization and in vitro release study of carvacrol-loaded chitosan nanoparticles. Colloids and Surfaces B: Biointerfaces, 84, 163-171.
Kester, J. y Fennema, O. (1986). Edible films and films: A review. Food Technology, 48, 47-59.
Kester, J. y Fennema, O. (1989ª). Resistance of lipid films to oxygen transmission. Journal of the American Oil Chemists' Society, 66, 1129-1138.
Kester, J. y Fennema, O. (1989b). The influence of polymorphic form on oxygen and water vapor transmission through lipid films. Journal of the American Oil Chemists' Society, 66, 1147-1153.
Khan, A., Khan, R., Salmieri, S., Le Tien, C., Ried, B., Bouchard, J., Chauve, G., Tan, V. Kamal, M., Lacroix, M. (2012). Mechanical and barrier properties of nanocrystalline cellulose reinforced chitosan based nanocomposite films. Carbohydrate Polymers, 90, 1601-1608.
Khan, M. S., Fon, D., Li, X., Tian, J., Forsythe, G., Shen, W. (2010). Biosurface engineering through ink jet printing. Colloids and Surfaces B: Biointerfaces, 75, 441-447.
Khoee, S., Sattari, A., Atyabi, F. (2012). Physico-chemical properties investigation of cisplatin loaded polybutyladipate (PBA) nanoparticles prepared by w/o/w. Materials Science and Engineering, 32, 1078-1086.
Khunawattanakul, W., Puttipipatkhachorn, S., Rades, T., Pongjanyakul, T. (2010). Chitosan-magnesium aluminum silicate nanocomposite films: physicochemical characterization and drug permeability. Int. J. Pharm, 393, 220-230.
Kim, S, Fernandes, M., Matamá, T., Loureiro, A., Gomes, A., Cavaco-Paulo, A. (2013). Chitosan-lignosulfonates sono-chemically prepared nanoparticles: Characterisation and potential applications. Colloids and Surfaces B: Biointerfaces, 103, 1-8.
Kipphan, H. (2001). Handbook of Print Media: Technologies and Production Methods. Springer. 1-1207.
Koebnik, R., Locher, K. y van Gelder, K. (2000). Structure and funtion of bacterial outer membrane protein: barrels in a nutshell. Mol. Microbiol, 37, 239-253.
Kong, M., Guang Chen, X., Xing, K., Park, H. J. (2010). Antimicrobial properties of chitosan and mode of action: A state of the art review. International Journal of Food Microbiology, 144, 51-63.
Koontz, J. L. (2006). Special delivery: Controlled release of active ingredients from food and beverage packaging. Blacksburg, Va., EEUU: Department of Food Science and Technology Virginia Tech.
Koutsopoulos, S. (2012). Molecular fabrications of smart nanobiomaterials and applications in personalized medicine. Advanced Drug Delivery Reviews, 64, 1459-1476.
Kowalczyk, P., y Holyst, R. (2008). Efficient adsorption of super greenhouse gas (tetrafluoromethane) in carbon nanotubes. Environmental science technology, 42(8), 2931-2936.
Krochta, J. (1997a). Edible films In A. Brody and K. Marsh (eds), The Wiley Encyclopedia of Packaging Technology. pp 397-401. John Wiley & Sons, New York.
Krochta, J. (1997b). Edible composite moisture barrier films In B. Blakistone (ed), Packaging Yearbook: 1996. pp 38-54. National Food Processors Association, Washington, D.C.
Krochta, J. (1997c). Edible protein films and films. In S. Damodaran and A. Paraf (eds), Food Proteins and Their Applications pp. 529-549. Marcel Dekker, New York.
Krochta, J. y De Muller-Johnston, C. (1997). Edible and biodegradable polymer films: challenges and opportunities. Food Technology, 51(2), 61-74.
Krochta, J., Baldwin, E. y Nisperos-Carriedo, M. (1994). Edible films and films to improve food quality. Florida, United States of America. CRC Press.
Krochta, J. (2002). Proteins as raw materials for films and films: definitions, current status, and opportunities, In A. Gennadios (ed), Protein Based Films and Films Pp 1-41. CRC Press, Boca Raton, Fla.
Kroupitski, Y., Golberg, D., Belausov, E., Pinto, R., Swartzberg, D., Granot, D., Sela, S., (2009). Internalization of Salmonella enterica in leaves is induced by light and involves chemotaxis and penetration through open stomata. Applied and Environmental Microbiology, 75, 6076-6086.
Kwok, D. Y., y Neumann, A. W. (1999). Contact angle measurement and contact angle interpretation. Advances in Colloid and Interface Science, 81(3), 167-249.
La Storia, A., Ercolini, D., Marinello, F., Di Pasqua, R., Villani, F., Mauriello, G. (2011). Atomic force microscopy analysis shows surface structure changes in carvacrol-treated bacterial cells. Research in Microbiology, 162, 164-172.
Lacroix, M., Outtara, B. (2000). Combined industrial processes with irradiation to assure innocuity and preservation of food products—A review. Food research international, 33, 719-724.
Laemmi, U. (1970). Cleavage of structural proteins during the assembly of head of bacteriophage T4. Nature, 227, 680-685.
Lai, H. y Padua, G. (1997). Properties and microstructure of plasticized zein films. Cereal Chemistry, 74(6), 771-775.
Lagaron, J. M., Cabedo, L., Cava, D., Feijoo, J. L., Gavara, R., Gimenez, E. (2005). Improving packaged food quality and safety. Part 2: Nanocomposites. Food Additives and Contaminants, 22(10), 994-998.
Langmuir, I. (1916): The constitution and fundamental properties of solids and liquids. part I: solids. J. Amer. Chem. Soc., 38, 2221-2295.
Lawrie, G., Keen, I., Drew, B., Chandler-Temple, A., Rintoul, L., Fredericks, P. y Grondahl, L. (2007). Interactions between alginate and chitosan biopolymers characterized using FTIR and XPS. Biomacromolecules, 8, 2533-2541.
Lee, D., Hwang, Y., y Cho, S. (1998). Developing antimicrobial packaging film for curled lettuce and soybean sprouts. Food Science and Biotechnology. 7(2), 117-121.
Li, C., Krewerb, G., Ji, P., Schermd, H., y Kayse, S. (2010). Gas sensor array for blueberry fruit disease detection and classification. Postharvest Biology and Technology, 55, 144-149.
Lin, S. Y., Wang, W. J., Lin, L. W., Chen, L. J. (1996). Systematic effects of bubble volume on the surface tension measured by pendant bubble profiles. Colloids and Surfaces A: Physicochemical and Engineering Aspects, 114, 31-39.
Little, C., L., Taylor, F., C., Sagoo, S., K., Gillespie, I., A., Grant, K., McLauchlin, J., (2007). Prevalence and level of Listeria monocytogenes and other Listeria species in retail pre-packaged mixed vegetable salads in the UK. Food Microbiol. 24, 711-717.
Lloyd, L., Kennedy, J., Methacon, P., Paterson, M., Knill, C. (1998). Carbohydrate polymers as wound management aids. Carbohydr Polym, 37(3), 315-322.
Loke, W., Lau, S., Yong, L., Khor, E., Sum, C. (2000). Wound dressing with sustained anti-microbial capability. J Biomed Mater Res., 53(1), 8-17.
López-León, T., Ortega-Vinuesa, J., Bastos-González, D., y Elaissari, A. (2014). Thermally sensitive reversible microgels formed by poly(N-Isopropylacrylamide) charged chains: A Hofmeister effect study. Journal of Colloid and Interface Science, 426, 300-307.
Lordan, S., Kennedyb, J., E. y Higginbothamb, C., L. (2011). Cytotoxic effects induced by unmodified and organically modified nanoclays in the human hepatic HepG2 cellline. Appl. Toxicol. 31, 27-35.
Majeti, N., V., Kumar, R. (2000). A review of chitin and chitosan applications. Reactive & Functional Polymers, 46(1), 1-27.
Martín-Polo, M., Mauguin, C. y Voilley, A. (1992). Hydrophobic films and their efficiency against moisture transfer: influence of the film preparation technique. Journal of Agricultural and Food Chemestry, 40, 407-412.
Marzocca, M., A., Marucci, P., L, Sica, M., G., Alvarez, E., E. (2004). Listeria monocytogenes detection in different food products and environmental samples from a large chain of supermarkets in the city of Bahia Blanca (Argentina). Rev Argent Microbiol. 36, 179-8.
McHugh, T. y Krochta, J. (1994). Dispersed phase particle size effects on water vapor permeability of whey protein-beeswax edible emulsion films. Journal of Food Processing and Preservation, 18, 173-188.
McLauchlin, J., Mitchell, R. T., Smerdon, W. J., Jewell, K. (2004). Listeria monocytogenes and listeriosis. A review of hazard characterization for use in microbiological risk assessment of foods. Int. J. Food Microbiol, 92, 15-33.que. Journal of Agricultural and Food Chemestry, 40, 407-412.
Marzocca, M., A., Marucci, P., L, Sica, M., G., Alvarez, E., E. (2004). Listeria monocytogenes detection in different food products and environmental samples from a large chain of supermarkets in the city of Bahia Blanca (Argentina). Rev Argent Microbiol. 36, 179-8.
McHugh, T. y Krochta, J. (1994). Dispersed phase particle size effects on water vapor permeability of whey protein-beeswax edible emulsion films. Journal of Food Processing and Preservation, 18, 173-188.
McLauchlin, J., Mitchell, R. T., Smerdon, W. J., Jewell, K. (2004). Listeria monocytogenes and listeriosis. A review of hazard characterization for use in microbiological risk assessment of foods. Int. J. Food Microbiol, 92, 15-33.
Mead, P. S., Slutsker, L., Dietz, V., McCaig, L. F., Bresee, J. S., Shapiro, C. (1999). Food-related illness and death in the United States. Emerging Infectious Diseases, 5, 607-625.
Medina, E. (2013). Diseño y evaluación de películas en base a proteínas de quínoa y quitosano que comprenden agentes naturales nanoencapsulados para su aplicación en berries. Tesis Doctoral, Universidad de Chile.
Meléndez, P., Kane, K., Ashvar, C., Albrecht, M., Smith, P., (2008) Thermal inkjet application in the preparation of oral dosage forms: dispensing of prednisolone solutions and polymorphic characterization by solid-state spectroscopic techniques. J Pharm Sci. 97, 2619-36.
MM, S., y Krochta, J. (2007). Ascorbic acid-containing whey protein film films for control of oxidation. Journal of Agricultural and Food Chemistry, 55, 2964-2969.
Mohapatra, S., Mohapatra, S., Boyapalle, S., Hellermann, G. (2011).
Multifunctional Chitosan Nanocarriers For Gene Therapy. Technology & Innovation, 13(1), 27-37.
Mothershaw, A., S., y Javer, T. (2001). Antimicrobial activity of foods with different physico-chemical characteristics. International Journal of Food Properties, 7, 629-638.
Mukherjee, A., Speh, D., Jones, A. T., Buesing, K. M., Diez-Gonzalez, F., (2006). Longitudinal microbiological survey of fresh produce grown by farmers in the upper Midwest. Journal of Food Protection, 69, 1928-1936.
Müller, R. H., Jacobs, C., y Kayser, O. (2001). Nanosuspensions as particulate drug formulations in therapy rationale for development and what we can expect for the future. Advanced Drug Delivery Reviews, 47, 3-19.
Muzzarelli, R. (1977). Chitin. Oxford. Pergamon Press. 326 p.
Nelson, D., y Cox., M. (2006). Lehninger principles of biochemistry. 4th Edition, Freeman and Company, New York, 1216 pp., ISBN 0-7167-4339-6.
Nikaido, H. (2003). Molecular basis of bacterial outer membrane permeability revisited. Microbiol. Mol. Biol. Rev. 67, 593-656.
Nilsson, L., Christiansen, Y. Y., Jorgensen, J. N., Grotinum, B. L., Gram, D. (2006). The contribution of bacteriocin to inhibition of Listeria monocytogenes by Carnobacterium piscicola strains in coldsmoked salmon systems. J. Appl. Microbiol. 96, 133-143.
Nisperos-Carriedo, M. (1994). Edible films and films based on polysaccharides. In J. Krochta E. Baldwin M. Nisperos-Carriedo (eds), Protein-based films and films. Pp 305-335. Technomic Publishing Co., Inc. Lancaster, U.S.A.
Nordqvist, P., Khabbaz, F., y Malmstrom, E. (2010). Comparing bond strength and water resistance of alkali-modified soy protein isolate and wheat gluten adhesives. International Journal of Adhesion & Adhesives, 30(2), 72-79.
OFFICIAL CHILEAN STANDARD NCh1151.0f76. (1990). Plastic sheets and films.
OFFICIAL CHILEAN STANDARD NCh2098.0f2000. (2000). Organic coating films—Determination of water vapor transmission. 13 pp.
Obara, S. y McGinity, J. (1995). Influence of processing variables on the properties of free films prepared from aqueous polymeric dispersions by a spray technique. International Journal of Pharmaceutics, 37, 849-53.
Okamoto, T., Suzuki, T., Yamamoto, N. (2000). Microarray fabrication with covalent attachment of DNA using bubble jet technology. Nat. Biotechnol. 18, 438-441.
Olsson, E., Johansson, C., y Jarnstrom, L. (2014). Montmorillonite for starch-based barrier dispersion film—Part 1: The influence of citric acid and poly(ethylene glycol) on viscosity and barrier properties. Applied Clay Science, 97-98, 160-166.
Omidbeygi, M., Barzegar, M., Hamidi, Z., y Naghdibadi, H. (2007). Antifungal activity of thyme, summer savory and clove essential oils against Aspergillus Xavus in liquid medium and tomato paste. Food Control, 18, 1518-1523.
Ouattara, B., Simard, R., Piete, G., Bégin, A., y Holley, R. (2000). Diffusion of Acetic and Propionic Acids from Chitosan-based Antimicrobial Packaging Films. Journal of Food Science, 65(5), 768-773.
Ouyang, L., Malaisamy, R., y Bruening, M. (2008). Multilayer polyelectrolyte films as nanofiltration membranes for separating monovalent and divalent cations. Journal of Membrane Science, 310(1-2), 76-84.
Overhoff, K., A., Engstrom, J., D., Chen, B., Scherzer, B., D., Milner, T., E., Johnston, K., P., Williams III, R., O. (2007). Novel ultra-rapid freezing particle engineering process for enhancement of dissolution rates of poorly water-soluble drugs. European Journal of Pharmaceutics and Biopharmaceutics. 65, 57-67.
Pan, K., Chen, H., Davidson, M., y Zhong, Q. (2014). Thymol Nanoencapsulated by Sodium Caseinate: Physical and Antilisterial Properties. Journal of Agricultural and Food Chemistry, 62(7), 1649-1657.
Pardeike, J., Strohmeier, D., Schrodl, N., Voura, C., Gruber, M., Khinast, J., Zimmer, A. (2010). Nanosuspensions as advanced printing ink for accurate dosing of poorly soluble drugs in personalized medicines. INT J PHARM. 420, 93-100.
Park, H., J. (1999). Development of advanced edible films for fruits. Trends Food Sci. Technol., 10, 254-260.
Park, S., Lee, B., Jungc, S. y Park, H. (2001). Biopolymer composite films based on kcarrageenan and chitosan. Materials Research Bulletin, 36, 511-519.
Paseiro-Losada, P., Simal-Lozano, J., Paz-Abuin, S., López-Mahia, P., y Simal-Gandara, J. (1993). Kinetics of the hydrolysis of bisphenol A diglycidyl ether (BADGE) in water based food simulants. Implications for legislation on the migration of BADGEtype epoxy resins into foodstuffs. Fresenius' Journal of Analytical Chemistry, 345, 527-532.
Pawlak, A. y Mucha, M. (2003). Thermogravimetric and FTIR studies of chitosan blends. Thermochimica Acta, 396, 153-166.
Peniche, C., Arguelles, W., Gallardo, A., Elvira, C. y San Ramón, J. (2001). Quitosano: un polisacárido natural biodegradable y biocompatible con aplicaciones en biotecnología y biomedicina. Revista de Plásticos Modernos, 81(535), 81-91.
Pereda, M., Amica, G. y Marcovich, N. (2012). Development and characterization of edible chitosan/olive oil emulsion films. Carbohydrate Polymers, 87(2), 1318-1325.
Pereira de Abreu, D. A., Paseiro, P. L., Angulo, I., Cruz, J. M. (2007). Development of new polyolefin films with nanoclays for application in food packaging. European Polymer Journal, 43(6), 2229-2243.
Pérez-Gago, M. y Krochta, J. (2001). Lipid particle size effect on water vapor permeability and mechanical properties of whey protein/beeswax emulsion films. Journal of Agricultural Food Chemestry, 49, 996-1002.
Periago, P., Delgado, B., Fernandez, P., Palop, A. (2004). Use of carvacol and cymene to control growth and viability of Listeria monocitogenes cells and prediction of survivors using frequency distribution functions. Journal of Food Protection. 67: 1408-1416.
Philo, M. R.; Damant, A. P.; Castle, L. (1997). Reactions of Epoxide Monomers in Food Simulants Used to Test Plastics for Migration. Food Addit. Contam., 14(1), 75-82.
Pol, H., Dawson, P., Acton, J. y Ogale, A. (2002). Soy protein isolate/corn-zein laminated films: transport and mechanical properties. J. Food Sci., 67(1), 212-217.
Purvis, T., Vaughn, J., M., Rogers, T., L., Chen, X., Overhoff, K., A., Sinswat, P., Hu, J., McConville, J., T., Johnston, K., P., Williams III, R., O. (2006). Cryogenic liquids, nanoparticles and microencapsulation. International Journal of Pharmaceutics, 324, 43-50.
Rabea, E., Badawy, M., Stevens, C., Smagghe, G., y Steurbaut, W. (2003). Chitosan as Antimicrobial Agent: Applications and Mode of Action. Biomacromolecules by the American Chemical Society, 4(6), 1457-1465.
Ranhotra, G., Gelroth, J., Glaser, B., Lorenz, K. y Johnson, D. (1993). Composition and protein nutritional quality of quinoa. Cereal Chemistry, 70(3), 303-305.
Rangel, J., M., Sparling, P., H., Crowe, C., Griffin, P., M., Swerdlow, D., L. (2005). Epidemiology of Escherichia coli O157:H7 outbreaks, United States, 1982-2002. Emerg Infect Dis, 11(4), 603-9.
Rahman, S (1995). Food properties handbook. CRC press, Boca Raton, Fla.:1-83.
Sanitary Food Regulations. (2011).
Rhim, J., Hong, S., Park, H., y Perry, K. W. (2006). Preparation and characterization of chitosan-based nanocomposite films with antimicrobial activity. Journal of Agricultural and Food Chemistry, 54, 5814-5822.
Rice, J. (1995). Antimicrobial polymer food packaging. Food Processing. 56(4): 56-58.
Rockland, L. y Beuchat, L. (1987). Water Activity: Theory and applications to food. IFT Basic Symposium Series. New York, 1987.
Roda, A., Guardigli, M., Russo, C., Pasini, P., Baraldini, M. (2000). Protein microdeposition using a conventional ink-jet printer. Biotechniques, 28, 492-496.
Rojas-Grau, M., Tapia, F., Rodriguez, A., Carmonac, O., Bellosa, M. (2007). Alginate and gellan-based edible films as carriers of antibrowning agents applied on fresh-cut Fuji apples. Food Hydrocolloids, 21, 118-127.
Rooney, M. (1995). Acti_e Food Packaging. Glasgow, UK: Blackie Academic and Professional.
Ruales, J., Valencia, S. y Nair, B. (1993). Effect of processing on the physico-chemical characteristics of quinoa flour (Chenopodium quinoa Willd.). Starch/Starke, 45, 13-19.
Sambrook, J., Fritsch, E. F. y Maniatis, T. (1989). Molecular Cloning—A Laboratory Manual, 2nd Edition. Cold Spring Habour Laboratory Press, New York.
Sanpui, P., Murugadoss, A., Durga Prasad, P. V., Ghosh, S. S., Chattopadhyay, A. (2008). The antibacterial properties of a novel chitosan—Ag-nanoparticle composite. International Journal of Food Microbiology, 124, 142-146.
Savé, P. (2011). Elaboracion de nanopartículas de Quitosano e incorporación en películas de Quitosano-quinoa (Chenopodium quinoa Willd.). Memoria para optar al titulo profesional de ingeniero en alimentos. Universidad de Chile. Santiago-Chile.
Schmidt, V., Giacomelli, C. y Soldi, V. (2005). Thermal stability of films formed by soy protein isolate e sodium dodecyl sulfate. Polymer Degradation and Stability, 87, 25-31.
Scoutaris, N., Alexander, M., Gellert, P., Roberts, C., (2011). Inkjet printing as a novel medicine formulation technique, J. Control. Release. DOI:10.1016/j.jconrel.2011.07.033.
Sebti, I., Chollet, E., Degraeve, P., Noel, C., y Peyrol, E. (2007). Water sensitivity antimicrobial and physicochemical analyses of edible films based on HPMC and/or chitosan. Journal of Agricultural and Food Chemistry, 55, 693-699.
Shi, A-M., Wang, L-J., Li, D., y Adhikari, B. (2013). Characterization of starch films containing starch nanoparticles Part 1: Physical and mechanical properties. Carbohydrate Polymers, 96(2), 593-601.
Sherman, L. (1998). Biocides keep the bugs off your plastics. Plastics Technology, 44(2), 45-48.
Simatos, D., y Karel, M. (1998). Characterization of the conditions of water in foods physicochemical aspects, in food preservation by water activity, Ed by Seow, C. C., Elsevier, Amsterdam.:1-41.
Sinha Ray, S., y Bousmina, M. (2005). Biodegradable polymers and their layered silicate nanocomposites: in greening the 21st century materials world. Progress in Material Science, 50, 962-1079.
Sivapalasingam, S., Friedman, C. R., Cohen, L., Tauxe, R. V. (2004). Fresh produce: growing cause of outbreaks of foodborne illness in the United States, 1973 through 1997. Journal of Food Protection, 67, 2342-2353.
Smith, J., Hoshino, J., y Abe, Y. (1995). Interactive packaging involving sachet technology. In M. L. Rooney, Acti e Food Packaging, p. 143. Glasgow, UK: Blackie Academic and Professional.
Soares, R., Scremin, F. y Soldi, V. (2005). Thermal stability of biodegradable films based on soy protein and corn starch. Macromolecular Symposia, 229, 258-265.
Sorrentino, A., Gorrasi, G., y Vittoria, V. (2007). Potential perspectives of bionanocomposites for food packaging applications. Trends in Food Science & Technology, 18, 84-95.
Sreevinasan, K. (1998). Synthesis and preliminary studies on a β-cyclodextrin-coupled chitosan as a novel adsorbent matrix. Journal of Applied Polymer Science, 69(6), 1051-1055.
Staggemeier, B., Collier, T., Prazen, B., Synovec, R. (2005). Effect of solution viscosity on dynamic surface tension detection. Analytica Chimica Acta, 534, 79-87.
Stuchell, Y., y Krochta, J. (1994). Enzymatic treatments and thermal effects on edible soy protein films. Journal of Food Science, 59, 1332-1337.
Takeuchi, K., Frank, J. F. (2000). Penetration of Escherichia coli 0157: H7 into lettuce tissues as affected by inoculum size and temperature and the effect of chlorine treatment on cell viability. Journal of Food Protection, 63, 434-440.
Tang, C., Chen, N., Zhang, Q., Wang, K., Fu, Q., Zhang, X. (2009). Preparation and properties of chitosan nanocomposites with nanofillers of different dimensions. Polymer Degradation and Stability, 94, 124-131.
Tanja, R., Jarsek, B. (2009). Antimicrobial activity of rosemary extracts (Rosmarinus officinalis L.) against different species of Listeria. Acta agriculturae Slovenica, 93, 51-58.
Thunberg, R., L, Tran, T., T., Bennett, R., W., Matthews, R., N., Belay, N. (2002). Microbial evaluation of selected fresh produce obtained at retail markets. J Food Prot 65(4), 677-82.
Timmermann, E. (2003). Multilayer sorption parameters: BET or GAB values. Colloids and Surfaces A: Physicochemistry Engineering Aspects, 220, 235-260.
Tiwari, A., Mishra, A., Mishra, S, Kuvarega, A., Mamba, B. (2013). Stabilisation of silver and copper nanoparticles in a chemically modified chitosan matrix. Carbohydrate Polymers, 92, 1402-1407.
Tolstoguzov, V. (1997). Protein-polysaccharide interactions. In S. Damodaran and A. Paraf (eds), Food Proteins and Their Application. pp 171-198. Marcel Decker, New York.
Torres, A., Romero, J., Macan, A., Guarda, A., y Galotto, M. (2014). Near critical and supercritical impregnation and kinetic release of thymol in LLDPE films used for food packaging. The Journal of Supercritical Fluids, 85, 41-48.
Tripathi, P., y Dubey, N. (2004). Exploitation of natural products as an alternative strategy to control postharvest fungal rotting of fruit and vegetables. Postharvest Biology and Technology, 32, 235-245.
Toloba, M. P., Peltzer, M., Enriquez, N., Pollio, M. L. (2004). Grain sorption equilibria of quinoa grains. Journal of Food Engineering, 61(3), 365-371.
U. S. Department of Agriculture, Agricultural Research Service. (2005). USDA National Nutrient Database for Standard Reference, Release 18. Nutrient Data Laboratory Home Page. Available at: http://www.nal.usda.gov/fnic/ foodcomp. Accessed on Dicember, 10, 2012.
Valenzuela, C., Abugoch, L., Tapia, C. (2013). Quinoa protein-chitosan-sunflower oil edible film: Mechanical, barrier and structural properties. LWT—Food Science and Technology, 50, 531-537.
Valenzuela, C., Abugoch, L., Tapia, C., Gamboa, A. (2013). Effect of alkaline extraction on the structure of the protein of quinoa (Chenopodium quinoa Willd.) and its influence on film formation. International Journal of Food Science and Technology, 48, 843-849.
Vargas M, Albors A, Chiralt A, Chiralt A. (2011). Application of chitosan-sunflower oil edible films to pork meat hamburgers. Procedia—Food Science, 1, 39-43.
Vargas M, Albors A, Chiralt A, González-Martínez C. (2009). Characterization of chitosan-oleic acid composite films. Food Hydrocolloid, 23, 536-547.
Vargas, M., Perdones, A., Chiralt, A., Cháfer, M. y González-Martínez, C. (2011). Effect of homogenization conditions on physicochemical properties of chitosan based film forming dispersions and films. Food Hydrocolloids, 25, 1158-1164.
Vásconez, M., B., Flores, S., K., Campos, C., A., Alvarado, J., y Gerschenson, L., N. (2009). Antimicrobial activity and physical properties of chitosan-tapioca starch based edible films and films. Food Research International, 42, 762-769.
Vaughn, J., M., Gao, X., Yacaman, M., J., Johnston, K., O., Williams III, R., O (2005). Comparison of powder produce by evaporative precipitation into aqueous solution (EPAS) and spray freezing into liquid (SFL) technologies using novel Z-contrast STEM and complimentary techniques. European Journal of Pharmaceutics and Biopharmaceutics, 60, 81-89.
Velayutham, T., Abd-Majid, W., Ahmad, A., Kang, G. y Gan, S. (2009). Synthesis and characterization of polyurethane films derived from polyols synthesized with glycerol, phthalic anhydride and oleic acid. Progress in Organic Films, 66, 367-371.
Vieira, M., Silva, M., Santos, L. y Beppu, M. (2011). Natural-based plasticizers and biopolymer films: A review. European Polymer Journal, 47(3), 254-263.
Viroben, G., Barbot, J., Mouloungui, Z. y Gueguen, J. (2000). Preparation and characterization of films from pea protein. Journal of Agricultural and Food Chemistry 48, 1064-1069.
Wazed, A., Rajendran, S., Joshi, M. (2011). Synthesis and characterization of chitosán and silver loaded chitosan nanoparticles for bioactive polyester. Carbohydrate Polymers, 83, 438-446
Weber, K., y Osborn, M. (1969). The reliability of molecular weight determinations by dodecyl sulfate polyacrylamide gel electrophoresis. The Journal of Biological Chemistry, 244, 4406-4412.
Weitz, R. T., Harnau, L., Rauschenbach, S., Burghard, M., y Kern, K. (2008). Polymer nanofibers via nozzle-free centrifugal spinning Nano Letters, 8(4), 1187-1191.
Weng, Y., Chen, M., y Chen, W. (1997). Benzoyl chloride modified ionomer films as antimicrobial food packaging materials. International Journal of Food Science and Technology. 32: 229-234.
Wiles, J., Vergano, P., Barron, F., Bunn, J. y Testin, R. (2000). Water vapor transmission rates and sorption behavior of chitosan films. Journal of Food Science 65(7), 1175-11.
Wiles, J., Vergano, P., Barron, Yang, C., Huang, K., Lin, P., y Lin, Y. (2007). Using a cross-flow microfluidic chip and external crosslinking reaction for monodisperse TPP chitosan microparticles. Sensors and Actuators B, 124, 510-516.
Wong, D., W., S.; Tillin, S., J.; Hudson, J. S.; Pavlath, A. E. (1994). Gas exchange in cut apples with bilayer films. J. Agric. Food Chem., 42, 2 (10), 2278-2285.
Wright, K., Pike, O., Fairbanks, D. y Huber, C. (2002). Composition of atriplex hortensis, sweet and bitter Chenopodium quinoa seeds. Journal of Food Science 67(4), 1380-1383.
Wu, T., Zivanovic, S., Draughon, F. A., Conway, W. S., Sams, C. E., (2005). Physicochemical properties and bioactivity of fungal chitin and chitosan. J. Agric. Food Chem. 53, 3888-3894.
Xia, W., Liu, P., Zhang, J., Chen, J. (2011). Biological activities of chitosan and chitooligosaccharides. Food Hydrocolloids 25, 170-179.
Yamaguchi, I., Iizuka, S., Osaka, A., Monma, H., y Tanaka, J. (2003). The effect of citric acid addition on chitosan/hydroxyapatite composites. Colloids and Surfaces A: Physicochemical and Engineering Aspects, 214(1-3), 111-118.
Yang, C., Huang, K., Lin, P., y Lin, Y. (2007). Using a cross-flow microfluidic chip and external crosslinking reaction for monodisperse TPP-chitosan microparticles. Sensors and Actuators B, 124, 510-516.
Yildirim, I., y Yapici, B., (2007). Inhibition of conidia germination and mycelial growth of Botrytis cinerea by some alternative chemical. Pakistan Journal of Biological Science, 10(8), 1294-1300.
Yixiang, X., Xi, R., Milford, A. H. (2006). Chitosan/clay nanocomposite film preparation and characterization. Journal of Applied Polymer Science, 99(4), 1684-1691.
Yu, Z., García, A., S., Jhonston, K., P., Williams III R., O. (2004). Spray freezing into liquid nitrogen for highly stable protein nanostructured microparticles. European Journal of Pharmaceutics and Biopharmaceutics, 58, 529-537.
Zgurskaya, H. I. y Nikaido, H. (2000). Multidrug resistance mechanism: drug efflux across two membranes. Mol. Microbiol. 37: 219-225.
Thong, Y., Song, X., y Li, Y. (2011). Antimicrobial, physical and mechanical properties of kudzu starch-chitosan composite films as a function of acid solvent types. Carbohydrate Polymers, 84(1), 335-342.

1-23. (canceled)

24. Bioactive edible films preserving, keeping fresh and extending the shelf life of coated fruits comprising:
bioactive edible films that preserve, keep and extend the shelf life of coated fruits, comprising:
a matrix material, such as paper sheet, made up of 600-1,000 kDA molecular weight chitosan or a mixture thereof, and an aqueous quinoa protein extract, extracted at pH 11; and
one or more layers of a printable nanoparticle suspension composition made up of a 100 to 300 kDa low molecular weight chitosan solution and thymol with sodium tripolyphosphate dispersed in glycerol.

25. Bioactive edible films, according to claim 24, wherein the ratio between the low molecular weight chitosan solution and thymol with sodium tripolyphosphate is 2:1.

26. Bioactive edible films, according to claim 24, wherein the glycerol has a concentration between 20% v/v and 30% v/v.

27. Bioactive edible films, according to claim 24, wherein the aqueous thymol (T) solution is 0.1% w/v in 0.1 M citric acid or acetic acid 1% w/v.

28. Bioactive edible films, according to claim 24, wherein the concentration of the low molecular weight chitosan nanoparticles and thymol is 4.4±0.1 mg/ml.

29. A process for preparing edible bioactive films comprising the following steps of:
a) obtaining a material, such as a sheet of printable paper, comprising high molecular weight chitosan, or a mixture of high molecular weight chitosan and an aqueous quinoa protein extract, extracted at pH 11;
b) separately preparing a suspension of low molecular-weight chitosan nanoparticles and thymol; being stirred for 24 hours and then filtered,
c) additionally, mixing the solution obtained from point (b) with sodium tripolyphosphate to a 2:1 ratio by dripping (1.8 ml/min) using an infusion pump, and constantly stirring,
d) centrifuging the dispersion obtained from step (c),
e) dispersing the suspension as filtered from step (d) with glycerol; and
f) printing the dispersed nanoparticle suspension obtained from step (e) on one of the sides of the paper sheet of step (a).

30. A process for preparing edible bioactive films, according to claim 29, wherein glycerol is added to the nanoparticles obtained at a 20 and 30% v/v concentration.

31. A process for preparing bioactive edible films, according to claim 29, wherein printing is carried out via a thermal inkjet system.

32. Biopackages for preserving, keeping fresh and extending the shell life of the fruit therein contained, comprising bioactive edible films, wherein said bioactive films comprise:
one matrix material, such as paper sheet made up of high molecular weight chitosan having a molecular weight from 600 to 1,000 kDa, or a mixture thereof and an aqueous quinoa protein extract, extracted at pH 11; and
one or more layers of a printable suspension composition of nanoparticles made up of a chitosan suspension having a molecular weight between 100 and 300 kDa and thymol with glycerol-dispersed sodium tripolyphosphate.

33. A process for forming biopackages that preserve, keep fresh and extend the shelf life of the fruit therein contained, comprising the steps of:
folding the edible bioactive films of claim 24, leaving the printable side with nanoparticles facing inwardly;
sealing bioactive edible films; and
forming a bag.

34. The biopackages according to claim 32, wherein the fruit are selected from blueberries, strawberries, cherry tomatoes, cherries, and any combination of any of the foregoing.
